(19) United States
(12) Patent Application Publication
(10) Pub. No.: US 2015/0039636 A1
(43) Pub. Date: Feb. 5, 2015

(54) SYSTEMS AND METHODS FOR INTELLIGENTLY LINKING AND FORMATTING GENEALOGICAL STRUCTURES

(71) Applicants: Thomas W. Sederberg, Orem, UT (US); William A. Barrett, Provo, UT (US)

(72) Inventors: Thomas W. Sederberg, Orem, UT (US); William A. Barrett, Provo, UT (US)

(73) Assignee: BRIGHAM YOUNG UNIVERSITY, PROVO, UT (US)

(21) Appl. No.: 14/175,761

(22) Filed: Feb. 7, 2014

Related U.S. Application Data
(60) Provisional application No. 61/774,757, filed on Mar. 8, 2013.

(51) Int. Cl. G06F 17/30; G06F 17/22; G06F 17/21

(52) U.S. Cl. CPC G06F 17/30961; G06F 17/212; G06F 17/2247
USPC 707/755; 707/797

(57) ABSTRACT

Modeling genealogical trees that span multiple pages can include the creation and use of navigable links between related nodes. When it is determined that a display layout of a genealogical tree will span a plurality of viewable pages by a document viewer, a descendent node is identified that genealogical links directly to a related ancestor node on another page. A selectable ancestor page link is then created and displayed proximate the descendent relative node which, when selected, causes the viewer to render the page containing the ancestor relative node. A selectable descendent page link is also created and displayed proximate the ancestor relative node which, when selected, causes the viewer to render the particular page containing the descendent relative node. Intelligent formatting can also be used to identify and remove or refrain from displaying duplicate branches of the genealogical tree.

### CROSS-REFERENCE TO RELATED APPLICATIONS

This application claims the benefit of and priority to U.S. Provisional Patent Application Ser. No. 61/774,757, filed on Mar. 8, 2013 and entitled “SYSTEMS AND METHODS FOR INTELLIGENTLY LINKING AND FORMATTING GENEALOGICAL STRUCTURES,” which application is expressly incorporated herein by reference in its entirety.

### BACKGROUND

Genealogical modeling techniques commonly use simple hierarchical tree structures that visibly interlink children to their parents. With these types of structures, genealogical models extending only a few generations can be presented on a single page and are relatively easy to navigate and comprehend.

Some family trees, however, extend many generations and are not suitable for presentation on a single page due to spatial constraints. Trees spanning multiple pages can be unwieldy and relatively difficult to navigate. This is true, even when using a computing system to perform the navigation, and particularly when the genealogical model is rendered with a file format such as a PDF format (Portable Document Format) that represents the model the same way, independent of the application software, hardware, and operating system used to render the model.

A PDF file, for example, encapsulates a complete description of the fixed-layout of the model, including the text, fonts, graphics, and other information needed to display the document, such that the model rendered by the PDF viewer will be represented with the same layout, independent of the application software, hardware, and operating system used. This relatively static presentation of a family tree can make it difficult to navigate back and forth between the nodes in the family tree.

Occasionally, some family trees also include duplication of displayed data due to anomalous relationships existing between relatives (e.g., the marrying of cousins). For instance, it is possible for an extended grandparent in one line of the family tree to coexist at another location within another line in the same family tree. This type of duplication can cause unnecessary spanning of family trees across multiple pages, further highlighting the navigation problem addressed above.

In view of the foregoing, there is a need for improved systems for creating genealogical models of family trees and for tools that can be used to facilitate navigation through the nodes of family trees spanning multiple pages.

### BRIEF SUMMARY OF THE INVENTION

Modeling genealogical trees that span multiple pages can include the creation and use of navigable links between related nodes. When it is determined that a display layout of a genealogical tree will span a plurality of viewable pages by a document viewer, a descendent node is identified that genealogical links directly to a related ancestor node on another page. A selectable ancestor page link is then created and displayed proximate the descendent relative node which, when selected, causes the viewer to render the page containing the ancestor relative node. A selectable descendent page link is also created and displayed proximate the ancestor relative node which, when selected, causes the viewer to render the particular page containing the descendent relative node. Duplicate branches of the genealogical tree that include the same combination of interconnecting nodes can also be identified and removed from the tree or omitted from display.

In some embodiments of the invention, efficiently modeling and linking of a genealogical tree spanning multiple pages begins with the accessing of a corresponding genealogical file or online genealogical database containing a plurality of data items that identify family members, wherein the genealogical file or online genealogical database contains relationship information that is usable to define relations between individual family members.

The genealogical file or online genealogical database is then parsed to identify relationship links between the family members based on the relationship information. The genealogical tree is created from the parsed genealogical file or online genealogical database. The genealogical tree includes a hierarchical model that interlinks the family members as nodes within the genealogical tree based on the relationship links. In some instances, the genealogical tree includes a first descendent node and a plurality of ancestor nodes with one or more relative nodes interposed between and interlinking each ancestor node with the first descendent node with corresponding relationship links.

A Portable Document Format (PDF) viewer or other viewer can then be used to render at least a portion of the genealogical tree in a hierarchical layout that visually reflects the family members and the relationship links, the hierarchical layout spanning a plurality of viewable pages when viewed by the PDF viewer based on spatial constraints for rendering the family members and their relationship links.

If it is determined that the hierarchical layout will span a plurality of viewable pages, a descendent relative node can be identified on a particular page that is directly linked to an ancestor relative node that is displayed on a subsequent page. Then a selectable ancestor page link is created and displayed proximate the descendent relative node on the particular page that is operable, when selected, to cause the PDF viewer to render the subsequent page containing the ancestor relative node. A selectable descendent page link can also be created and displayed proximate the ancestor relative node on the subsequent page. This link is operable, when selected, to cause the PDF viewer to render the particular page containing the descendent relative node.

In some embodiments, the methods of the invention also include intelligent formatting. This intelligent formatting can include acts of identifying duplicate branches of the genealogical tree that include a same combination of interconnecting nodes and that occur at different locations within the genealogical tree and then removing or otherwise refraining from displaying at least one of the duplicate branches of the genealogical tree within the hierarchical layout.

### BRIEF DESCRIPTION OF THE DRAWINGS

To further clarify the above and other advantages and features of the present invention, a more particular description of the invention will be rendered by reference to specific embodiments thereof, which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a flowchart that includes various acts that can be performed for efficiently modeling and linking a genealogical tree spanning multiple pages with selectable navigation links;

FIG. 2 illustrates a flowchart that includes various acts that can be performed for efficiently modeling and formatting a genealogical tree that includes duplicate branches having the same combination of interconnecting nodes; and

FIGS. 3-47 show an example of a genealogical family tree represented in a hierarchical layout that visually reflects the family members and the relationship links according to an appropriate format and which includes some pages with selectable navigation links and that omits unnecessary duplication of identical node combinations.

### DETAILED DESCRIPTION

Embodiments of the invention include methods, systems and corresponding computer program products operable for creating and navigating genealogical structures.

Some embodiments of the invention include intelligent linking of interconnected nodes that are immediately related by a parent/child relationship (e.g., a parent and a child) and which span multiple pages. In these embodiments, the navigation or page links can facilitate intuitive navigation of the genealogical structures between the pages.

Other embodiments of the invention include intelligent reformatting of the hierarchical structure to reduce or eliminate duplicated presentation of identical combinations of nodes from the genealogical structures.

Efficient formatting for reducing white space can also be performed, in some embodiments, by forcing intrusions (e.g., moving a child node between two parent nodes) or by forcing other repositioning, resizing and/or relocating of the nodes in the tree.

As described throughout this paper, various techniques are used for creating or otherwise accessing genealogical models from corresponding genealogical files, online genealogical databases or other genealogical databases and data structures. These files can include gedcom (.ged) type files or any other files containing genealogical information (e.g., name data, birth data, death data, location data, parent relationship data, child relationship data, and/or any other genealogical information) and which is formatted with a suitable format that enables the data to be parsed and analyzed to identify corresponding relationships between individual family members contained in the genealogical information, including at least parent/child relationships.

In some instances, the genealogical file or online genealogical database includes an index that implicitly or explicitly identifies the parent and child relationships directly. In other embodiments, the genealogical file or online genealogical database does not include an index or the file is created by scraping another file or webpage having the genealogical information and the parent/child relationships.

The genealogical file or online genealogical database, regardless of how it is created or otherwise accessed, is used to create a genealogical tree. While various references are made to the term online genealogical database, it is noted that the invention can also be used with distributed genealogical databases online, as well as databases that are not online or that are not considered traditional genealogical databases. It is also noted that the terms “genealogical tree,” “genealogical model,” “family tree” and “tree” are used interchangeably herein.

The genealogical tree includes a plurality of related nodes. The term “node” refers to elements in the hierarchical structure of the tree that are children and/or parents. At times, the nodes are referred to as ancestor nodes or descendent nodes to convey a relative upstream or downstream relationship. For instance, a tree that maps relationships between a family having a child, a parent and a grandparent includes a first descendent node (the child), an ancestor node (e.g., the grandparent) and a relative node (the parent) interconnecting the first descendent node and the ancestor node. This relative node (the parent) is considered an ancestor node to the first descendent (the child) as well as a descendent node to the ancestor node (the grandparent).

Attention will now be directed to the Figures, which illustrate various embodiments of the invention.

Intelligent Linking

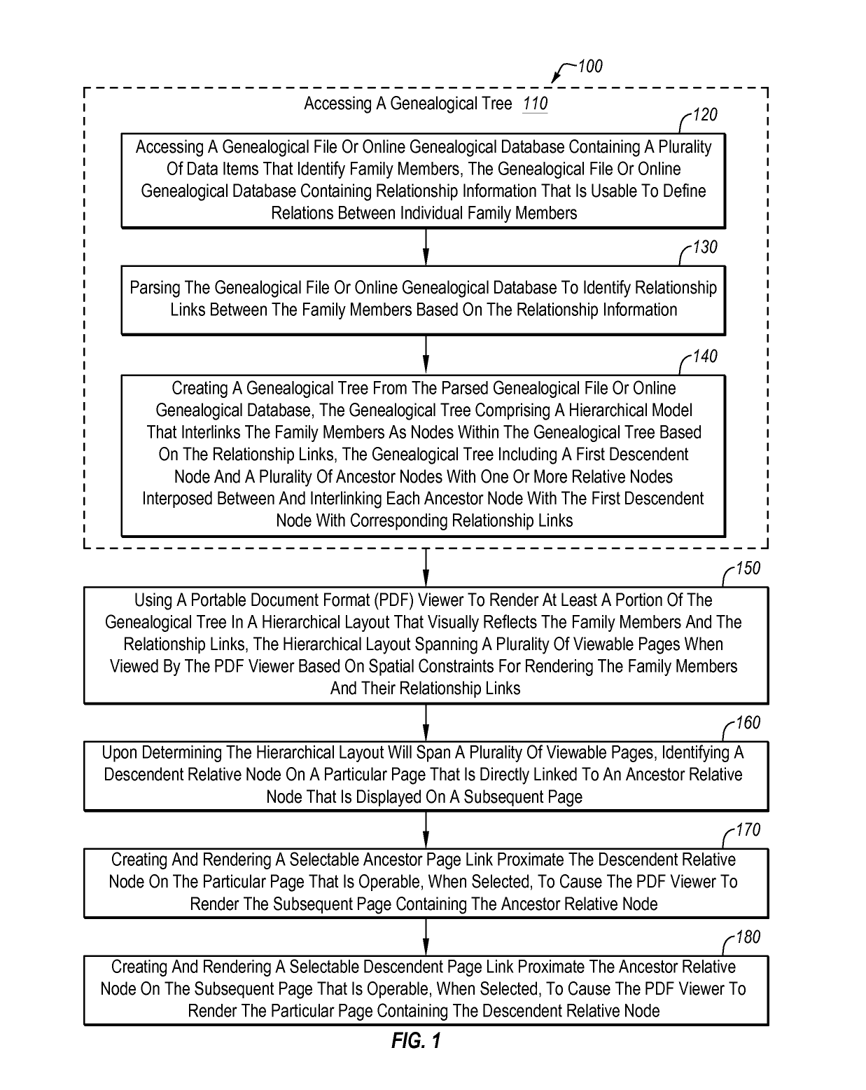

FIG. 1, for example, illustrates a flow diagram 100 of various acts that can be performed by a computing system for efficiently modeling a genealogical tree spanning multiple pages with navigable links. As shown, the method includes accessing a genealogical tree (110) to be used for modeling family relationships. This can be accomplished, for example, by first accessing a genealogical file or online genealogical database containing a plurality of data items that identify family members and that contain relationship information that is usable to define relations between individual family members (120). This file can be a gedcom type file or any other suitable file, as described above.

The genealogical file or online genealogical database is parsed to identify relationship links between the family members based on the relationship information (130) and a genealogical tree is created from the parsed genealogical file or online genealogical database (140). Notably, the genealogical tree comprises a hierarchical model that interlinks the family members as nodes within the genealogical tree based on parent/child relationships. The genealogical tree can include, for example, a first descendent node (a child) and a plurality of ancestor nodes (terminating or non-terminating leaf nodes) with one or more relative nodes (non-terminating leaf nodes) interposed between and interlinking each ancestor node with the first descendent node. The interlinking corresponds directly to corresponding parent/child relationships identified in the genealogical file or online genealogical database. A chain of interlinking nodes directly between a descendent node and an ancestor node with one or more interconnecting relative nodes is referred to as a genealogical line.

The genealogical tree or hierarchical representation of the genealogical file or online genealogical database can then be printed, displayed, or otherwise rendered at a suitable display medium (e.g., via print or by electronic display on a display screen).

In some embodiments, the tree is rendered on a display screen by using a Portable Document Format (PDF) viewer to render at least a portion of the genealogical tree in a hierarchical layout that visually reflects the family members as nodes and visible relationship links between the nodes to reflect their relative parent/child relationships (150). However, as should be apparent from the following, the display of the tree may not occur until after various other acts are performed, such as creating the ancestor page link and the descendent page links described below.

When displayed, the hierarchical layout of one or more lines can be contained on a single page or, alternatively, can span a plurality of pages based on spatial constraints (e.g., page size and font sizing) for rendering the various family members and/or depending on the length of the line(s) to be displayed (e.g., the number of generations displayed). Accordingly, prior to rendering the tree, the system can evaluate display and rendering constraints of the display medium and can format or reformat the tree for optimal presentation. For instance, the system can analyze size constraints of the display medium and the number of generations to display.

User preferences for font, object sizing, page numbering or other preferences can also be considered and used to make appropriate decisions for formatting/reformatting the tree. By way of example, the system can render a predetermined number of nodes with a desired font size within a predetermined vertical and/or horizontal dimension for each page that is used to render the tree based on the user preferences and/or display capabilities and the number of generations to be displayed. These constraints can be used to determine the number of nodes to be displayed in a horizontal and/or vertical alignment of the page. These constraints can also be mutually exclusive to or inclusive of first, second, third, fourth or later generation of nodes presented on any particular page. Formatting can also include coloring preferences to distinguish lines and/or generations of the tree to identify particularly relevant, interesting or different types of nodes.

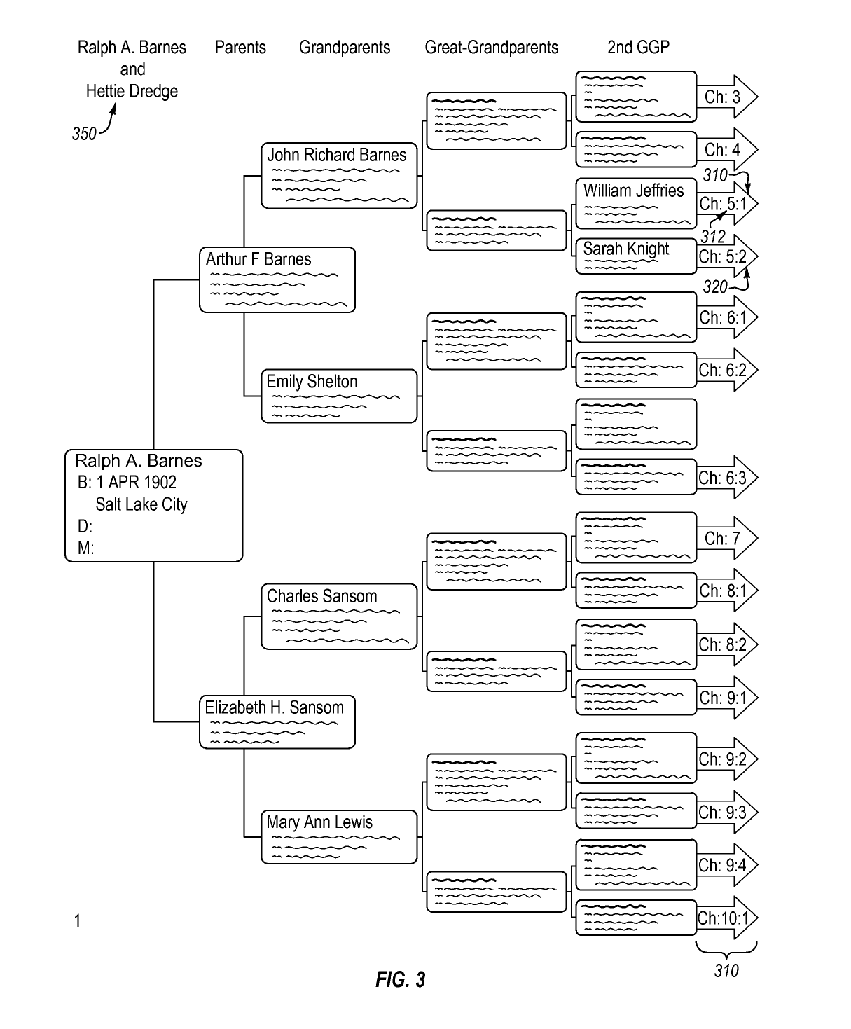

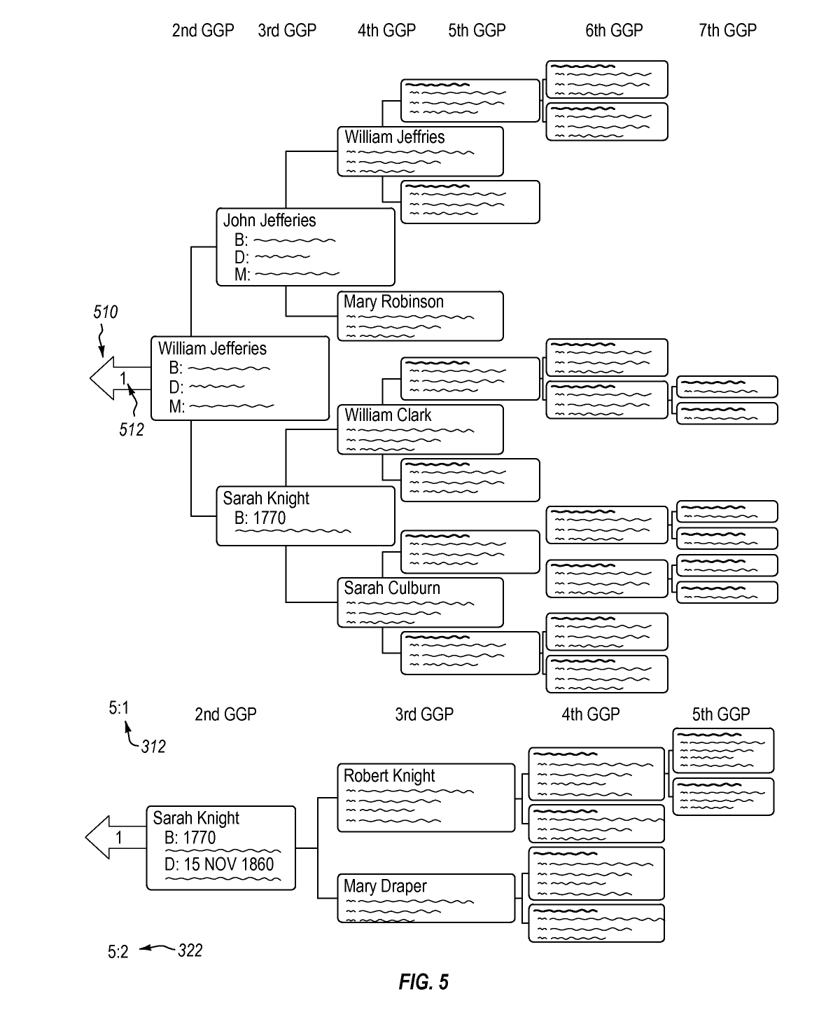

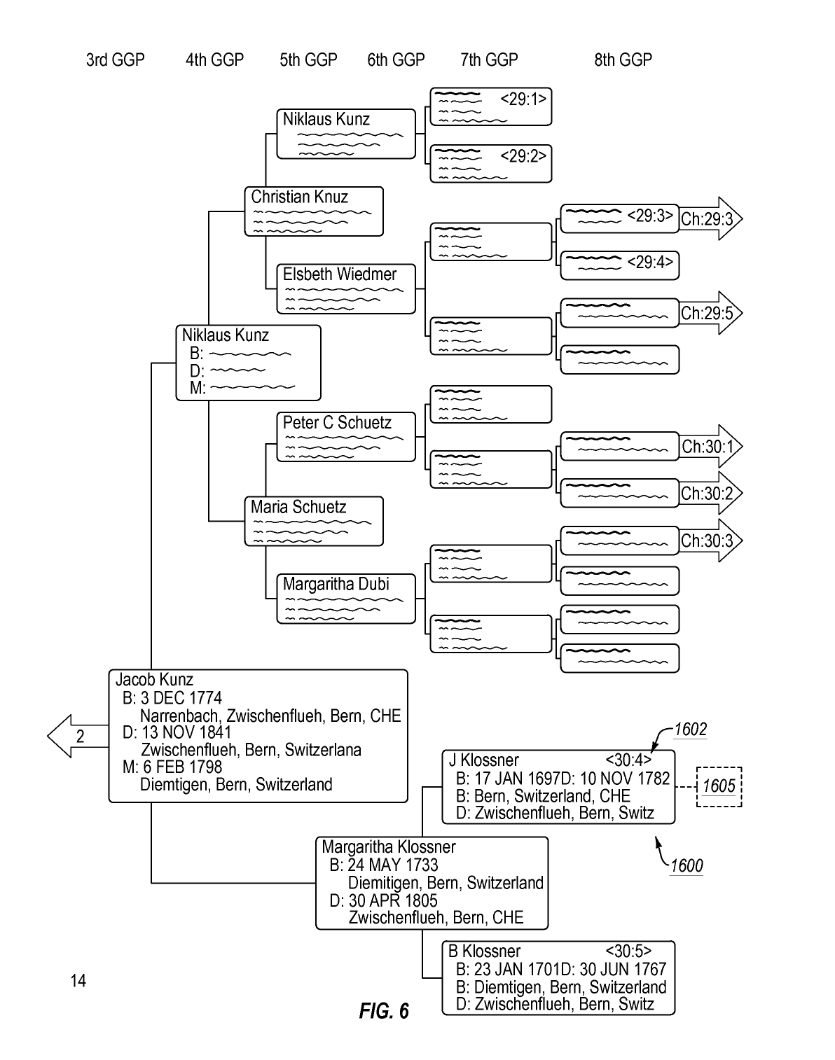

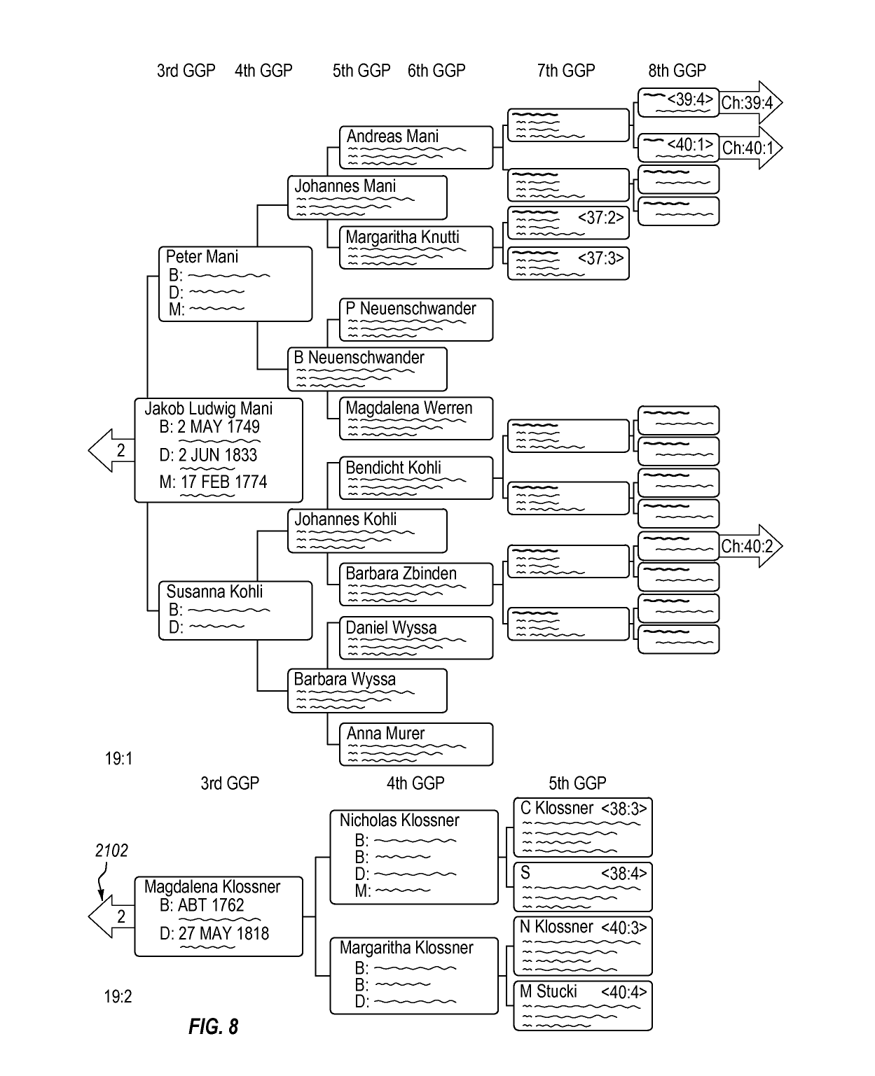

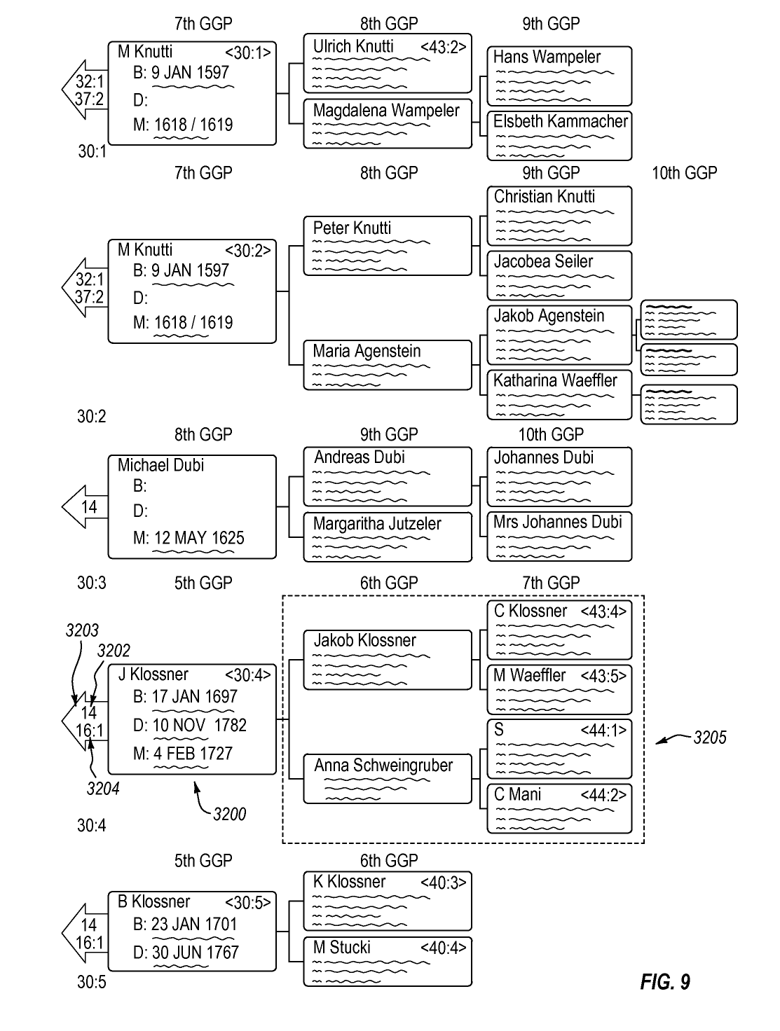

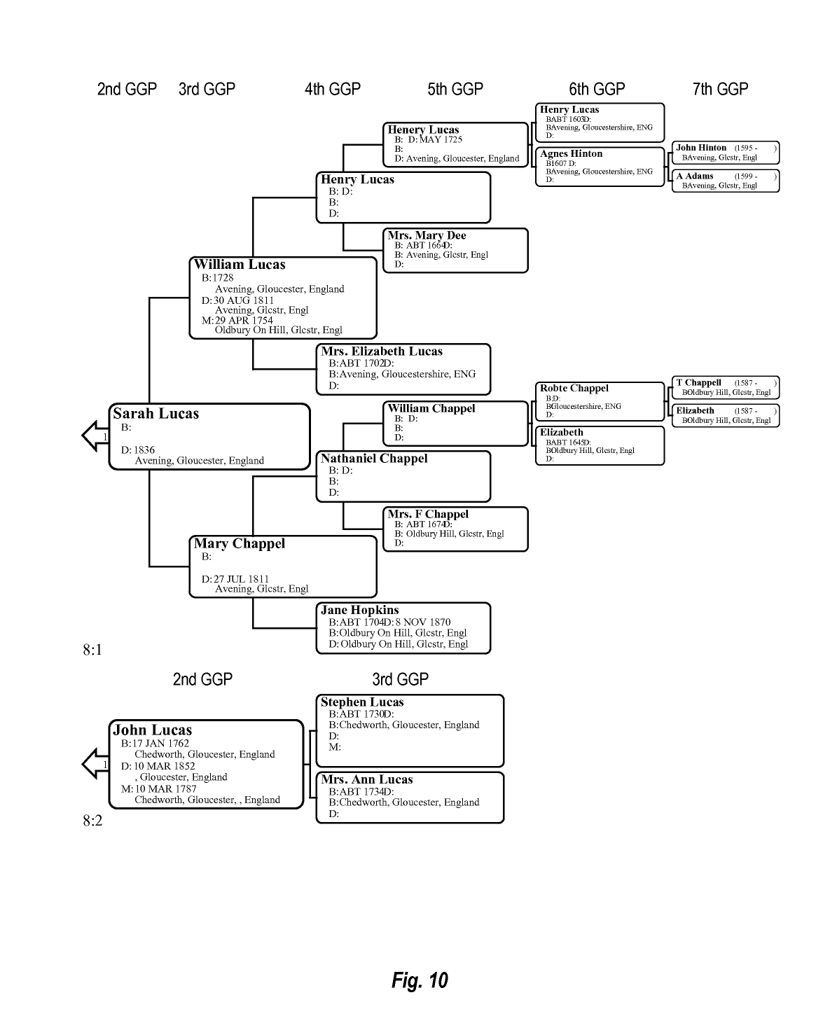

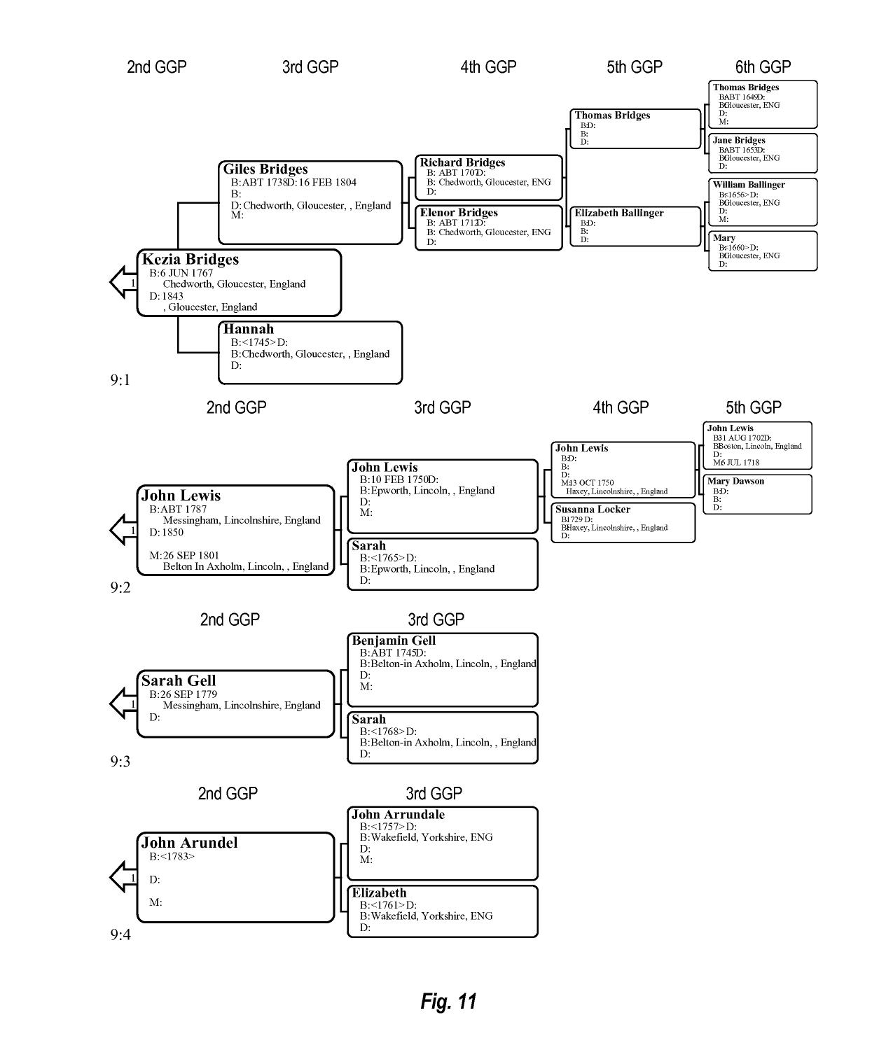

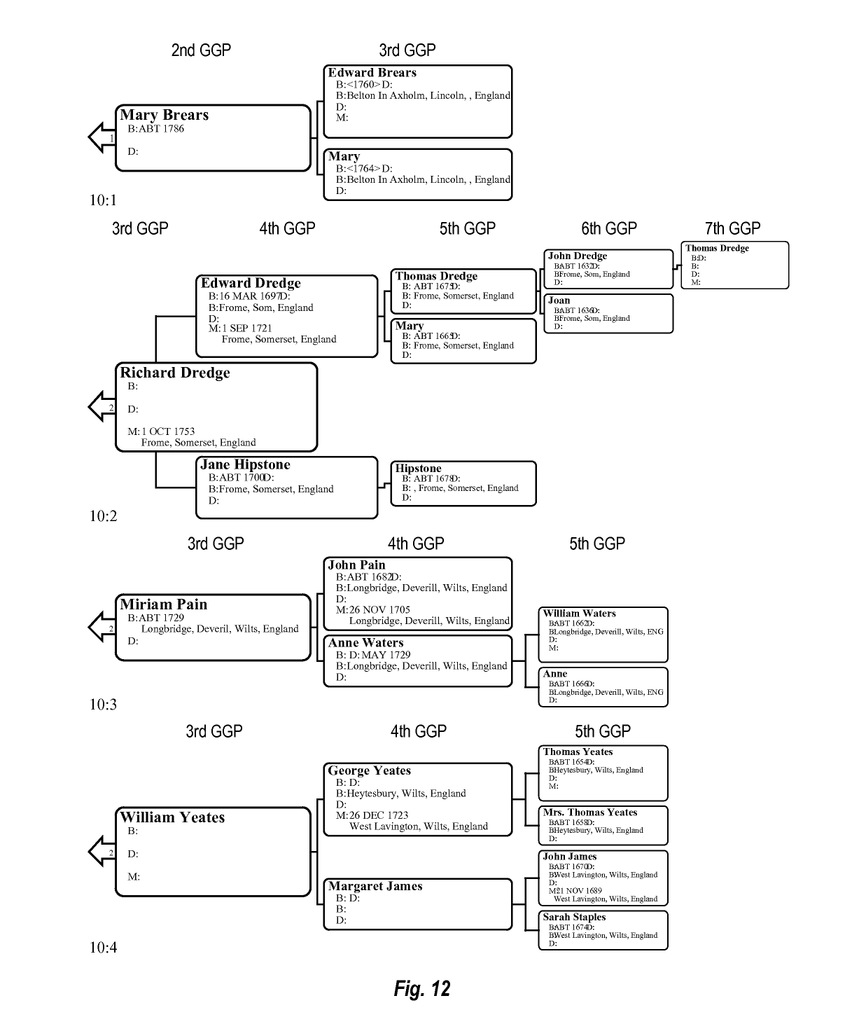

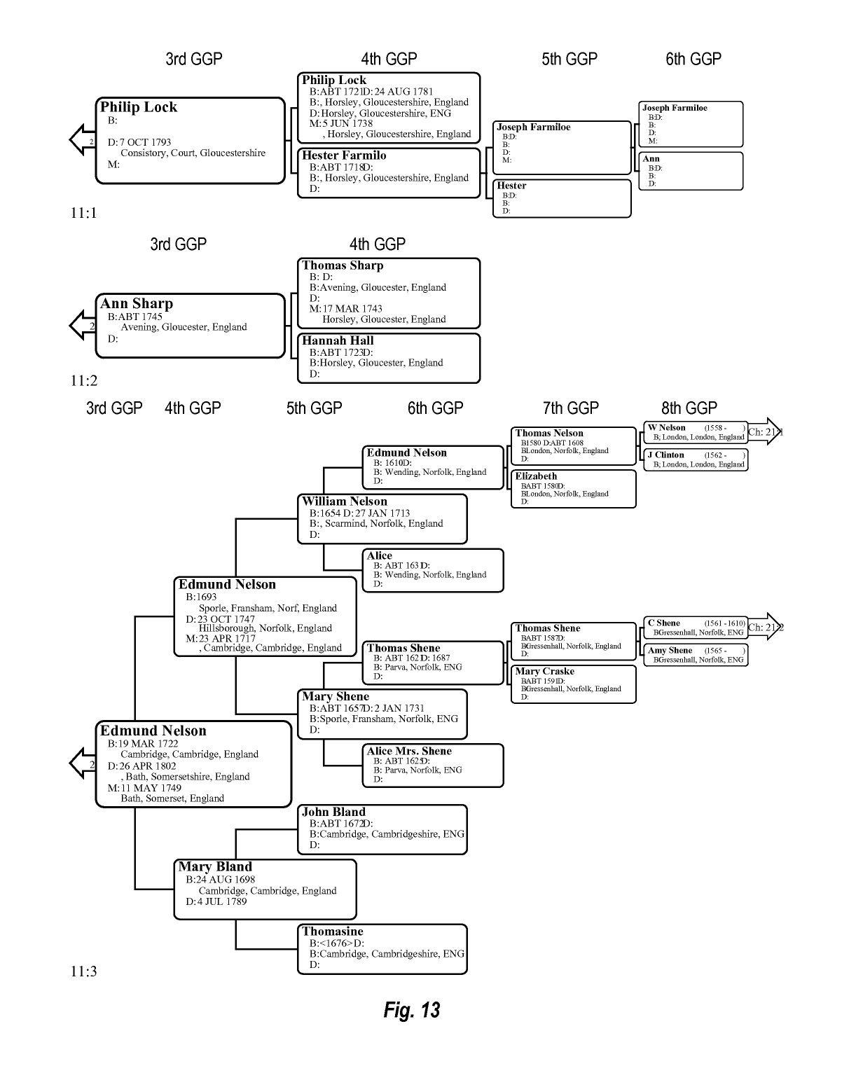

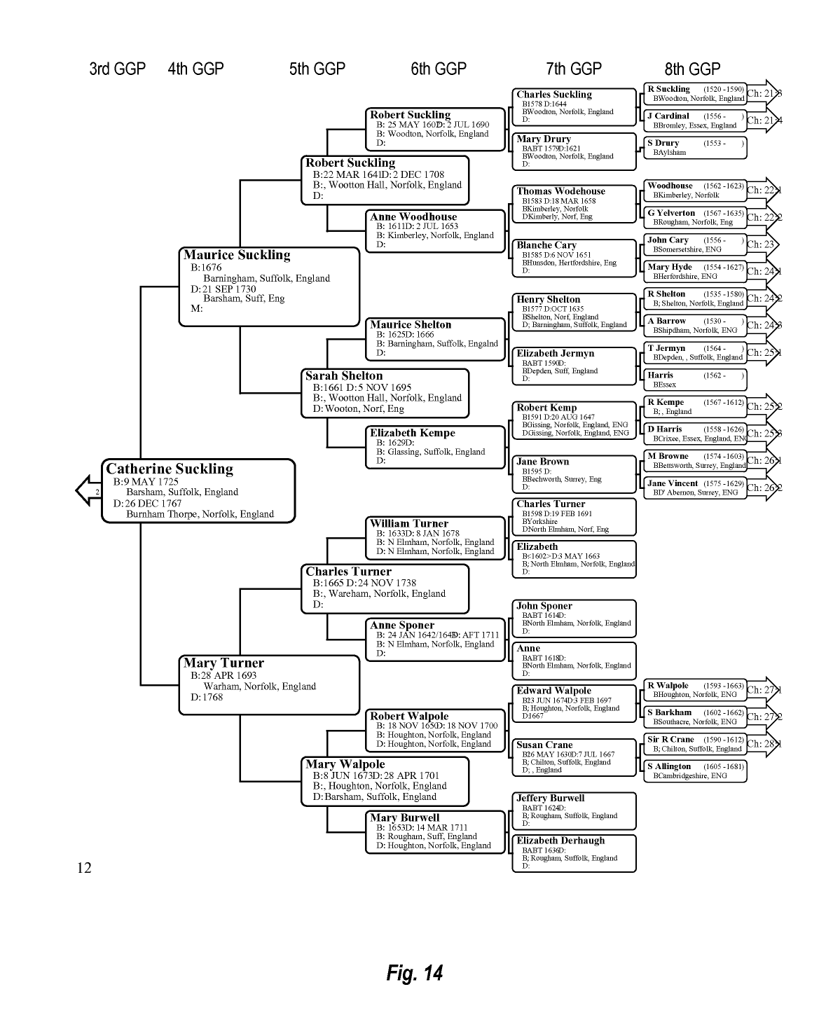

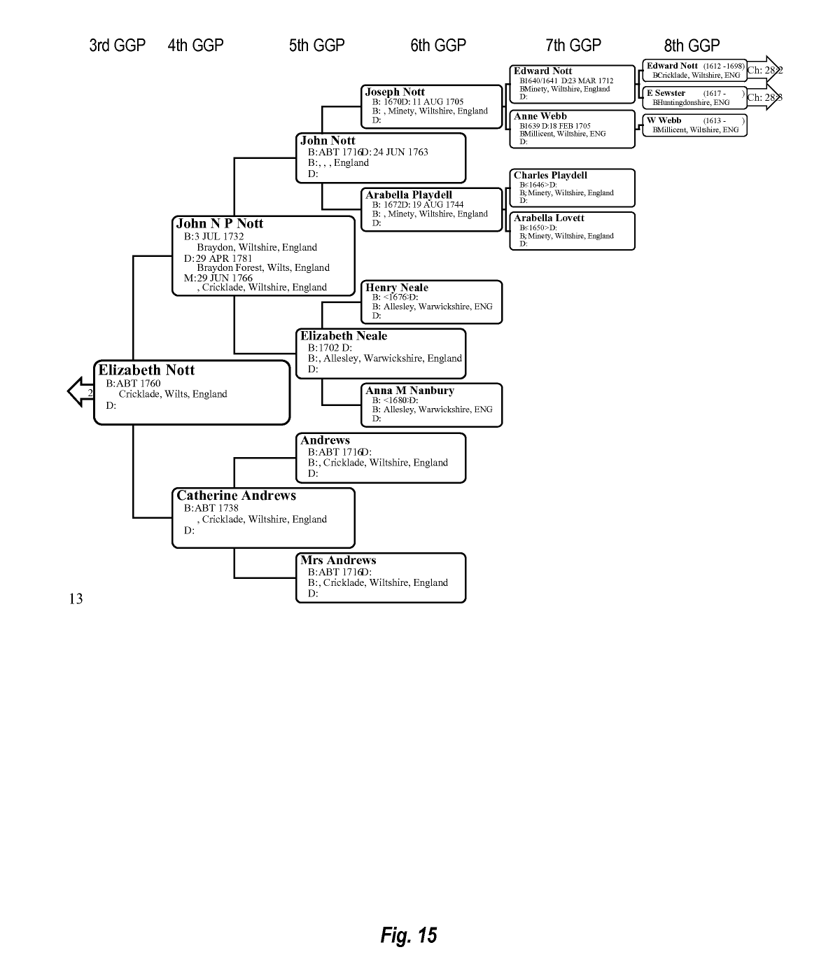

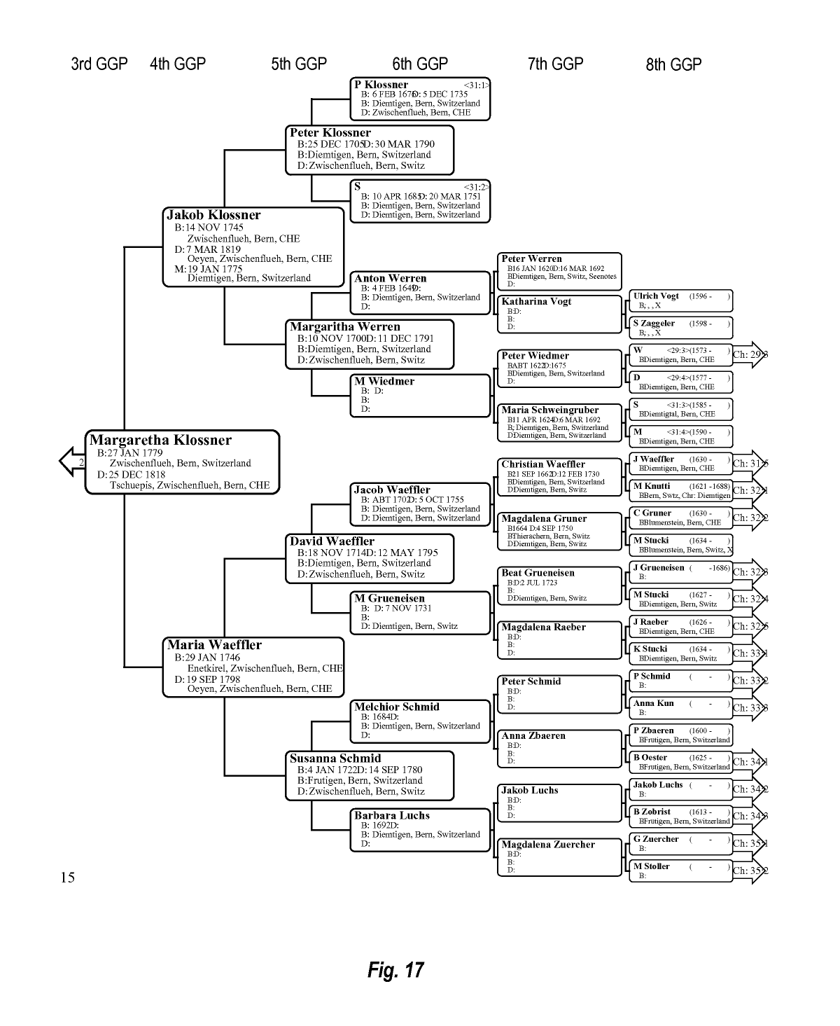

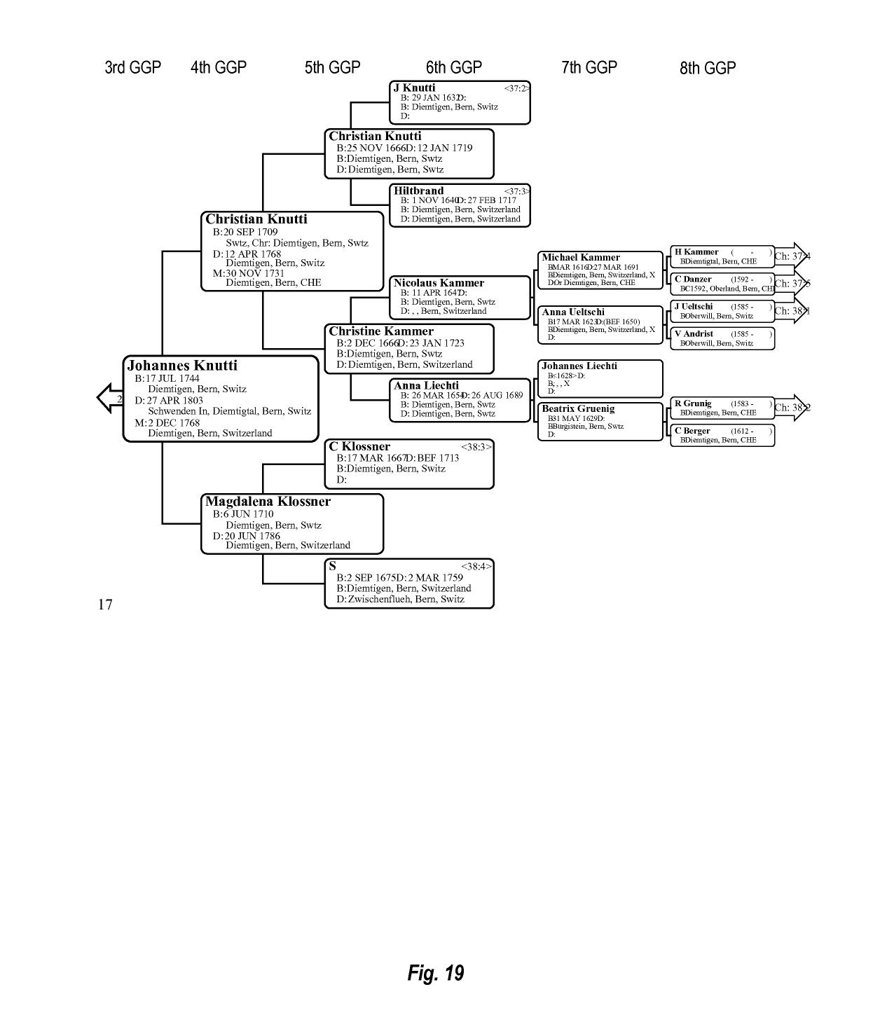

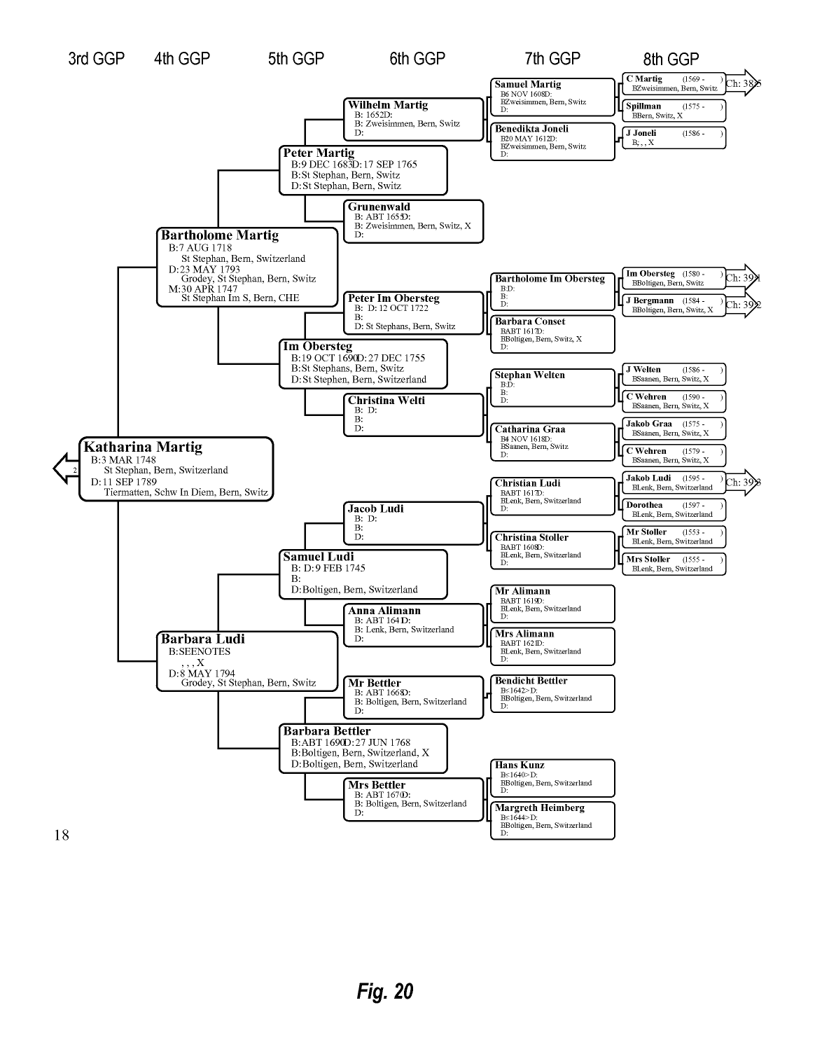

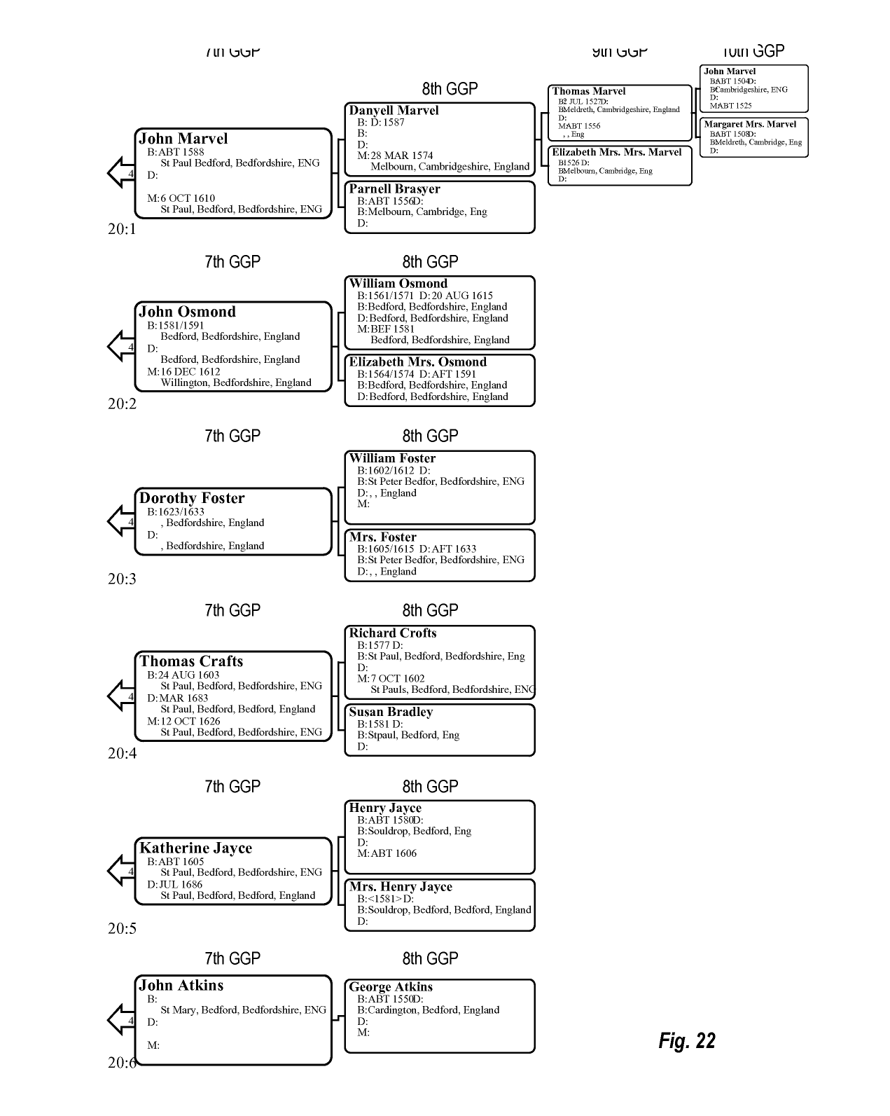

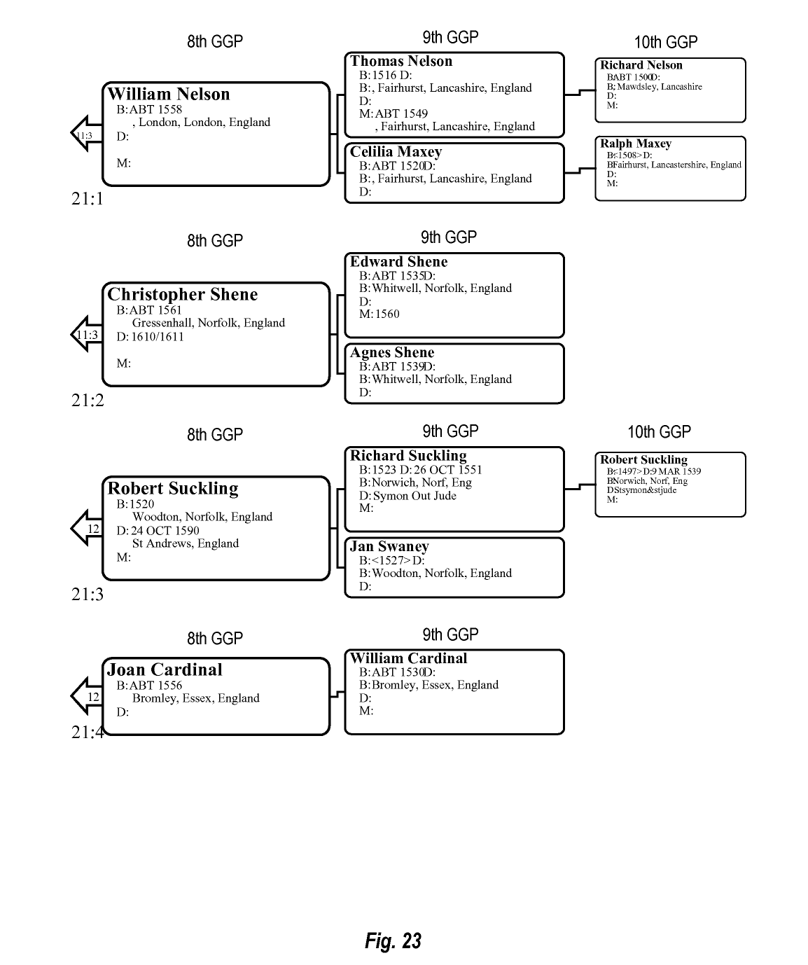

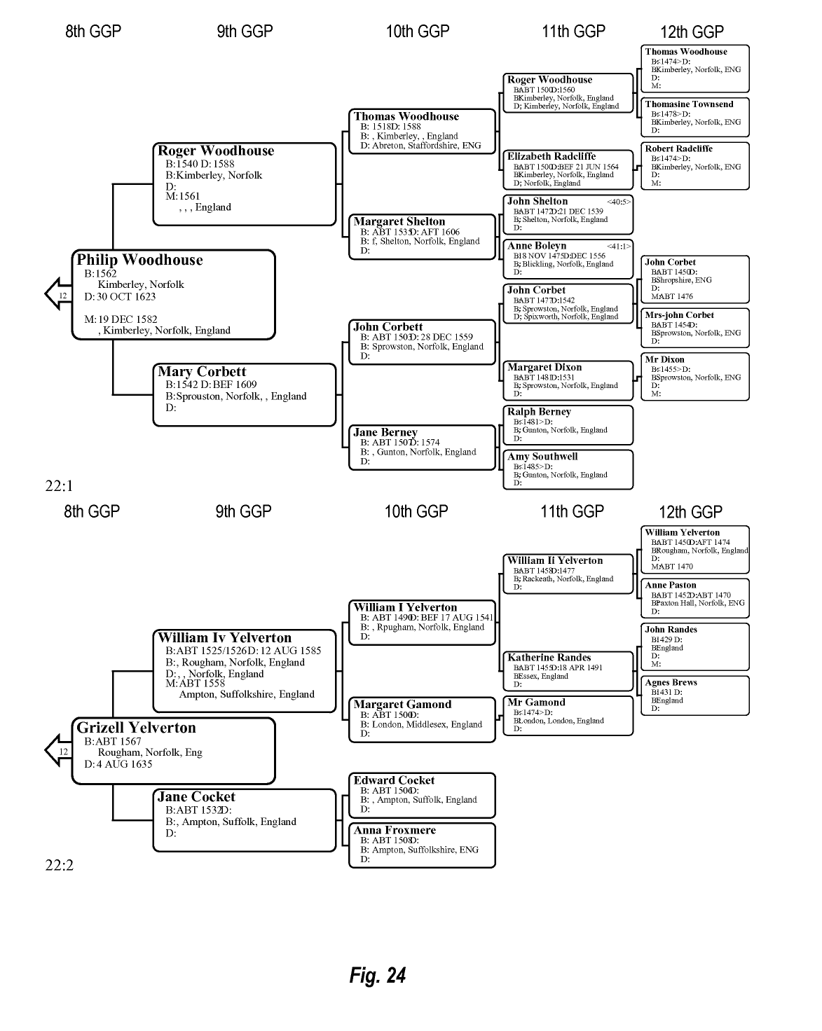

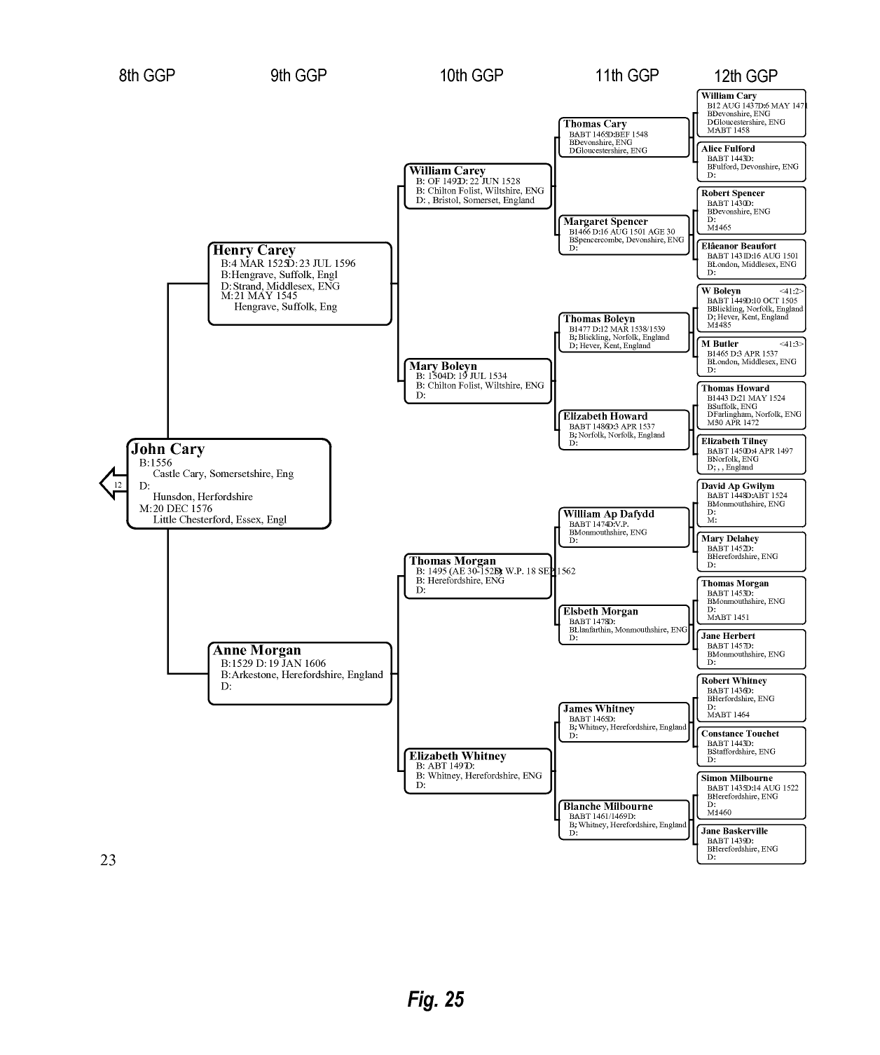

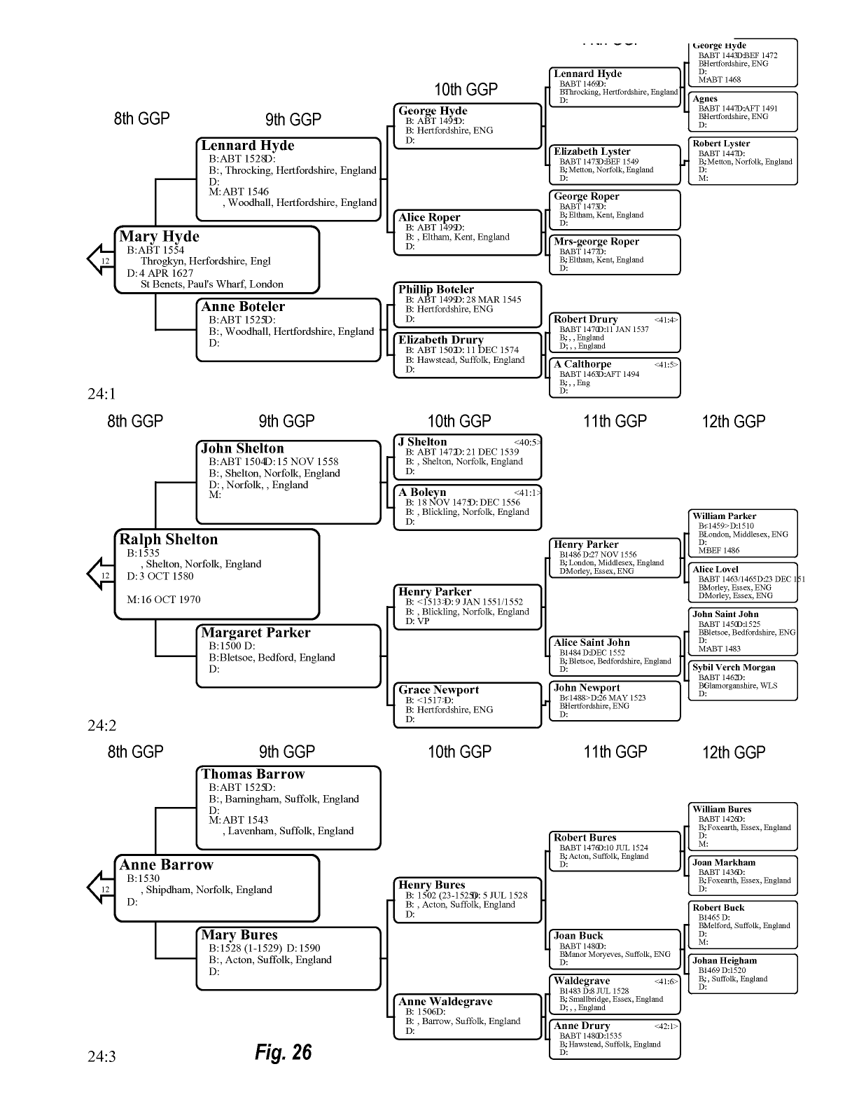

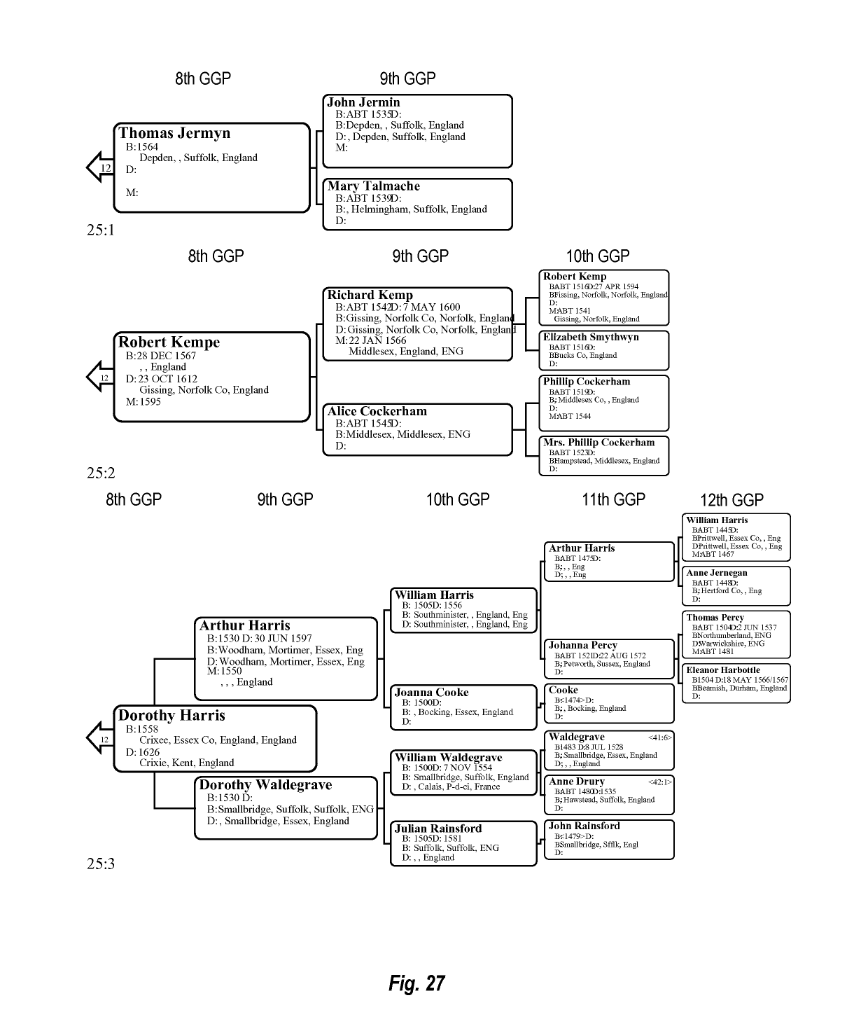

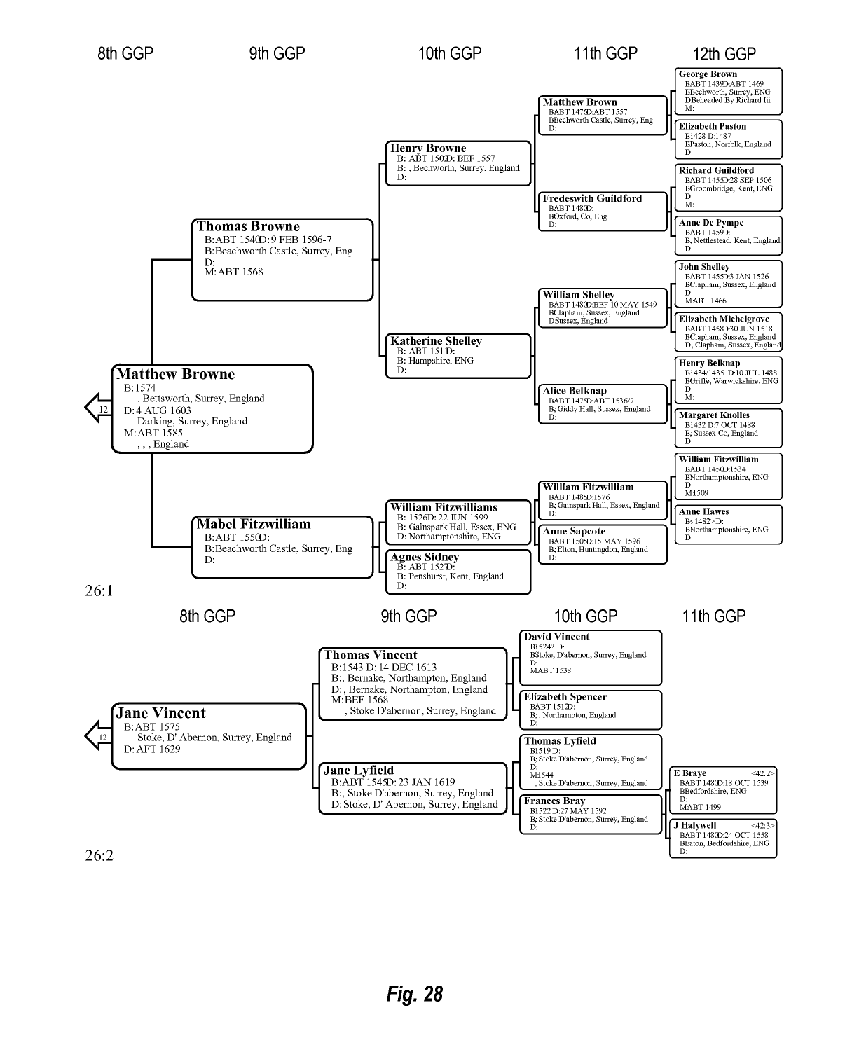

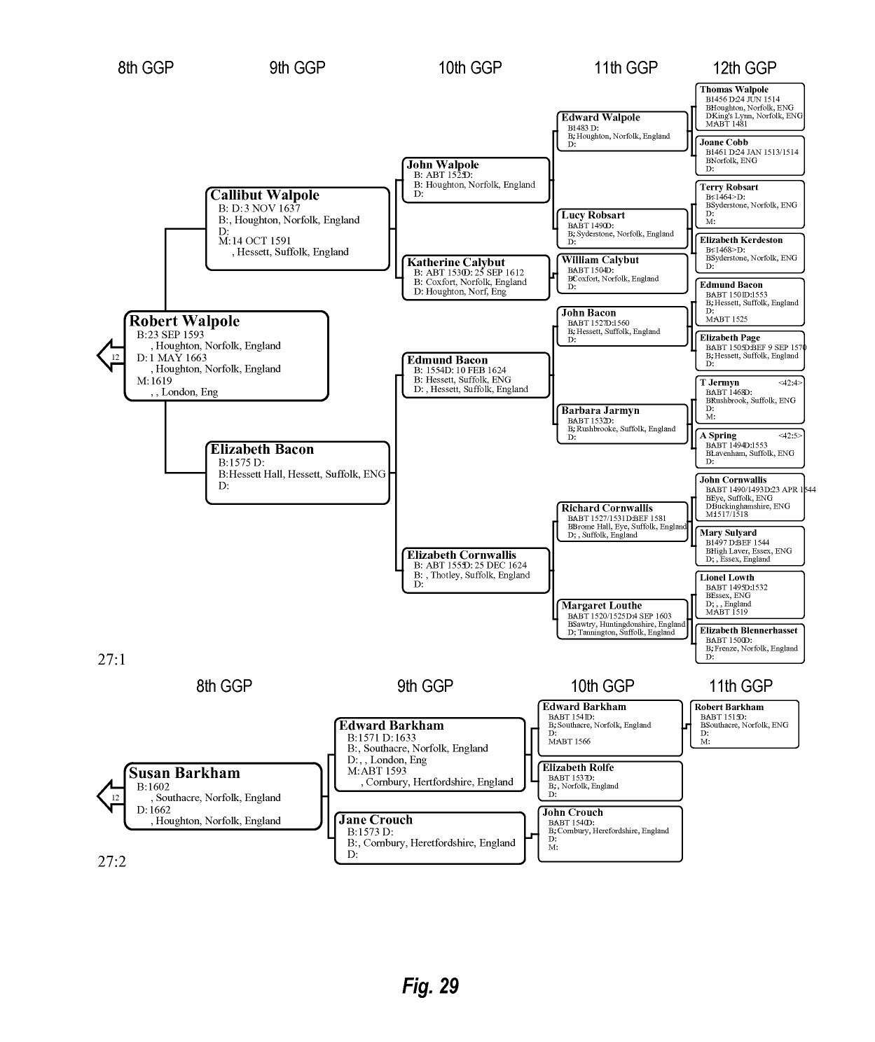

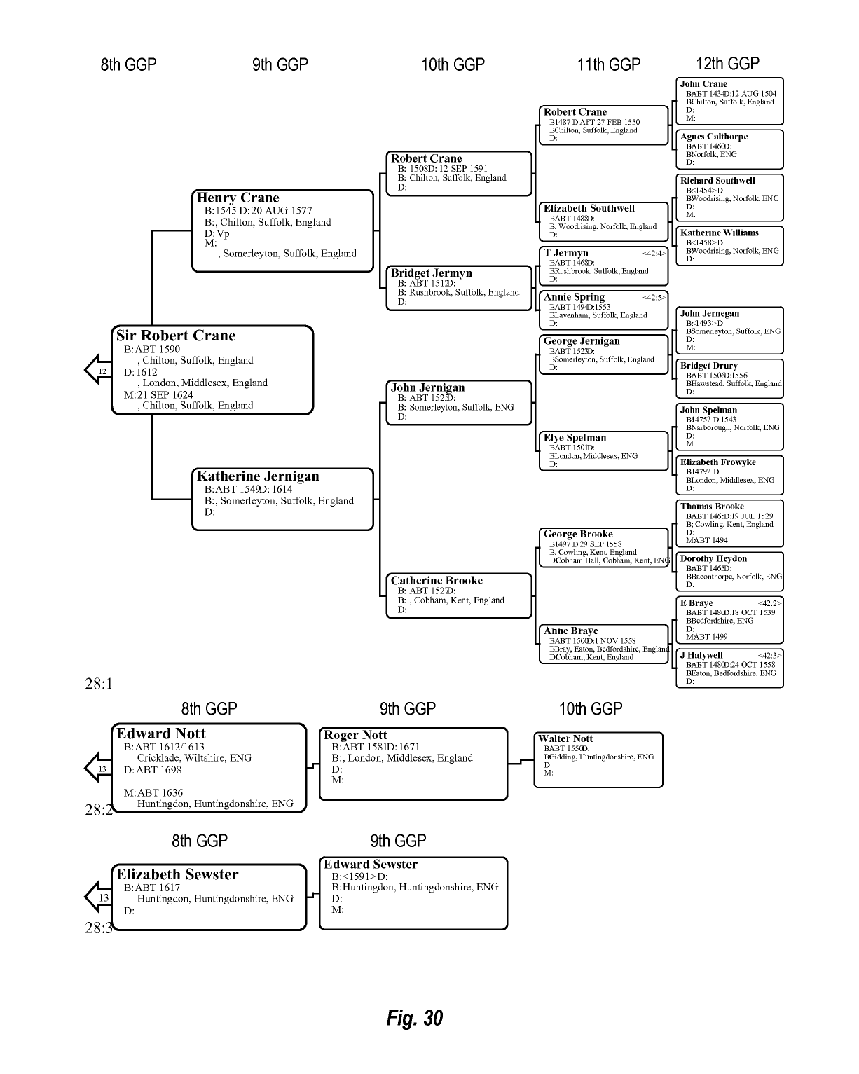

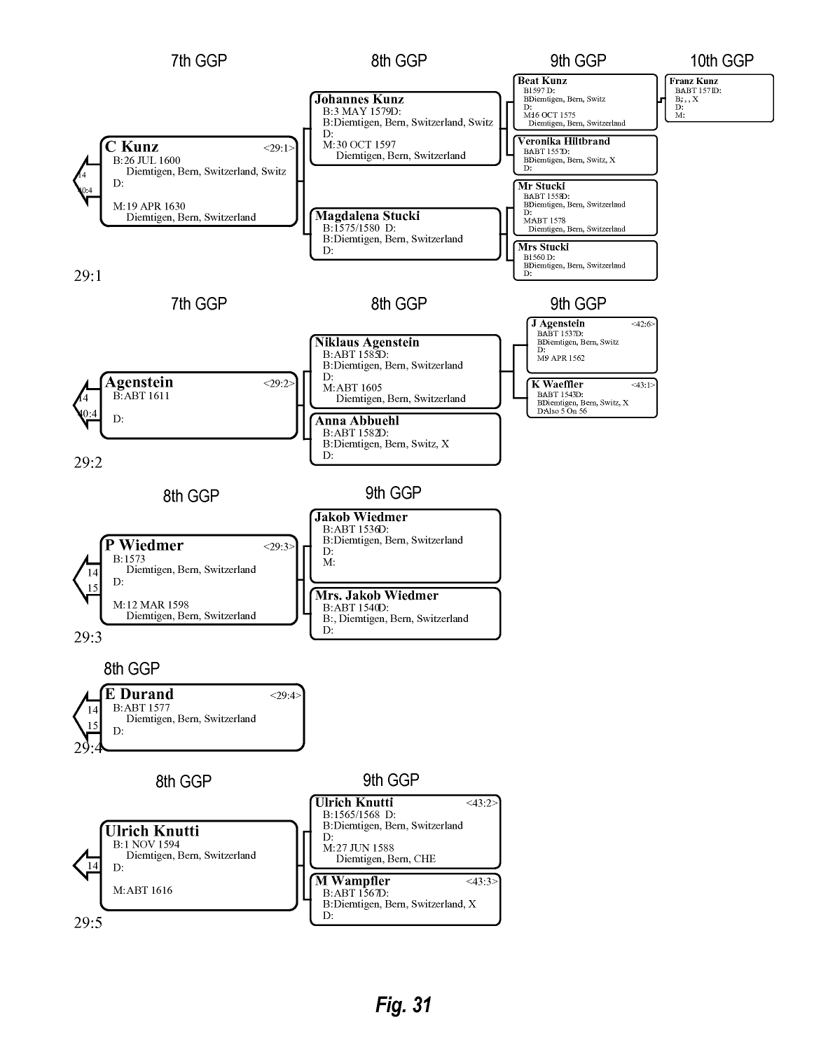

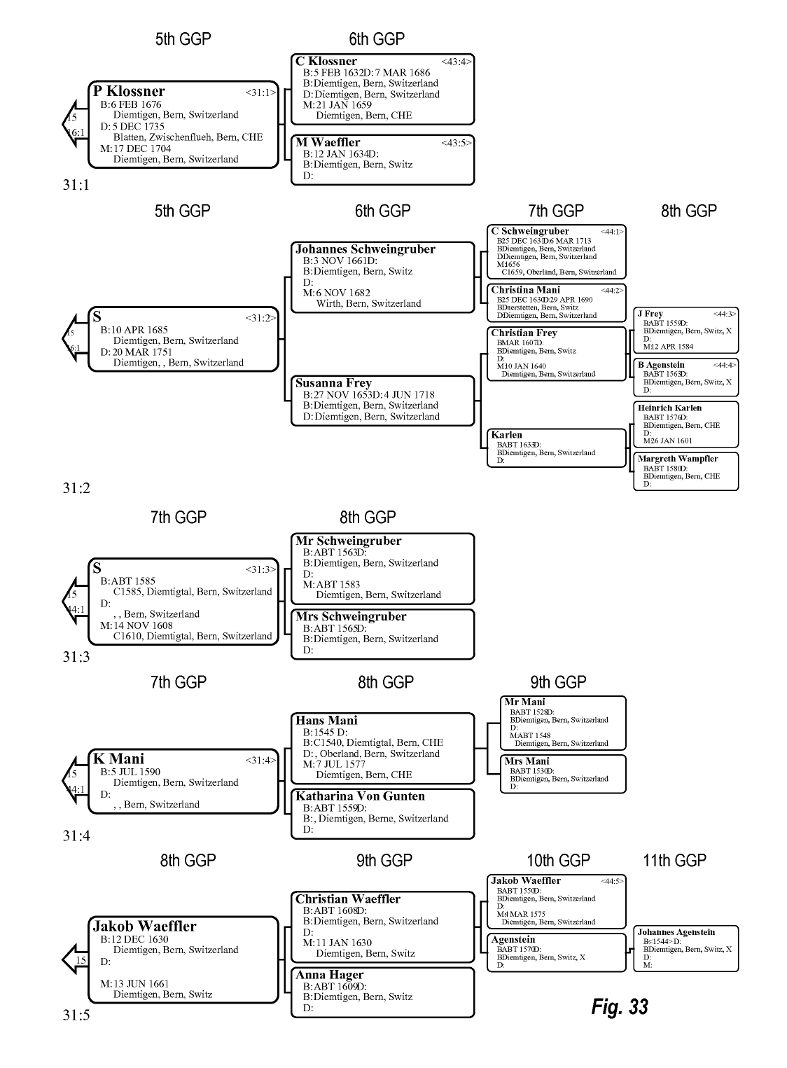

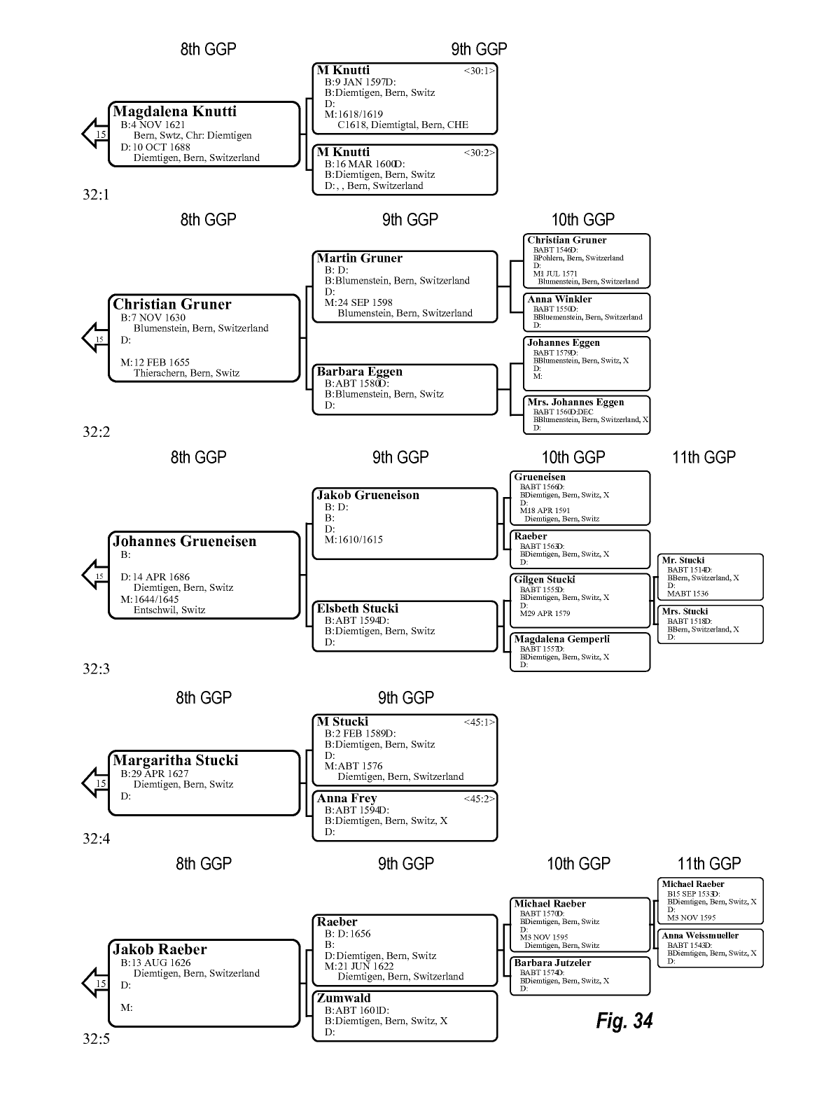

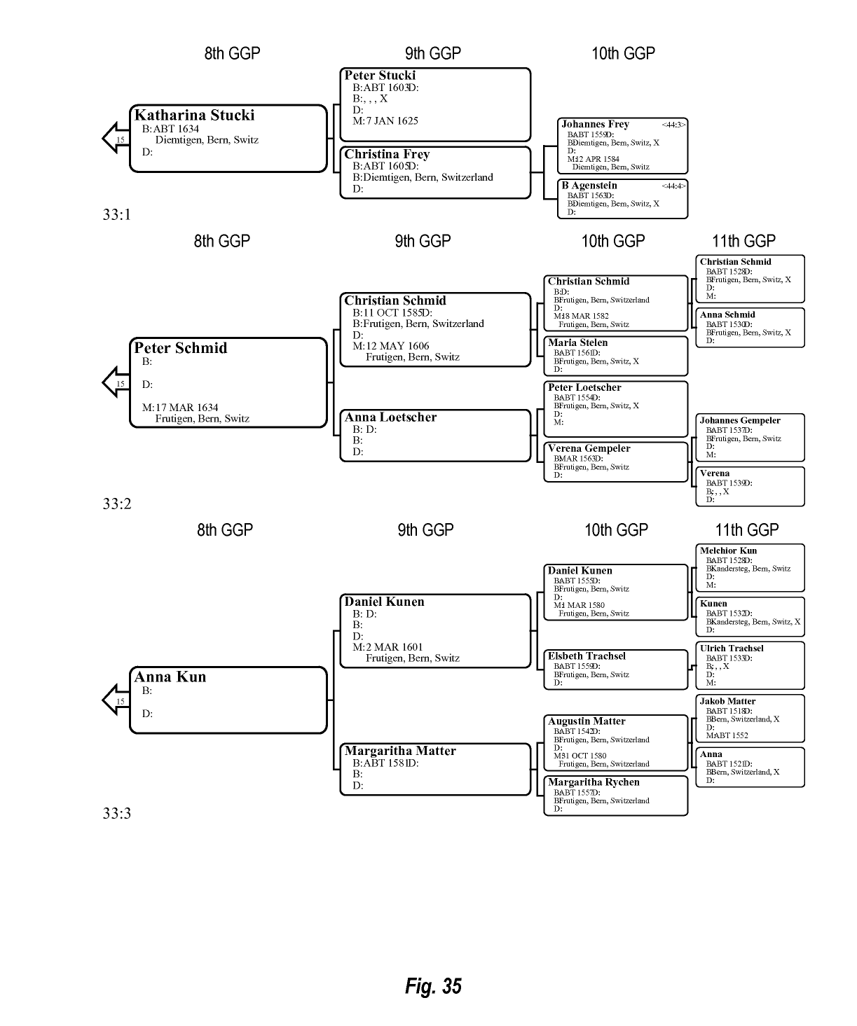

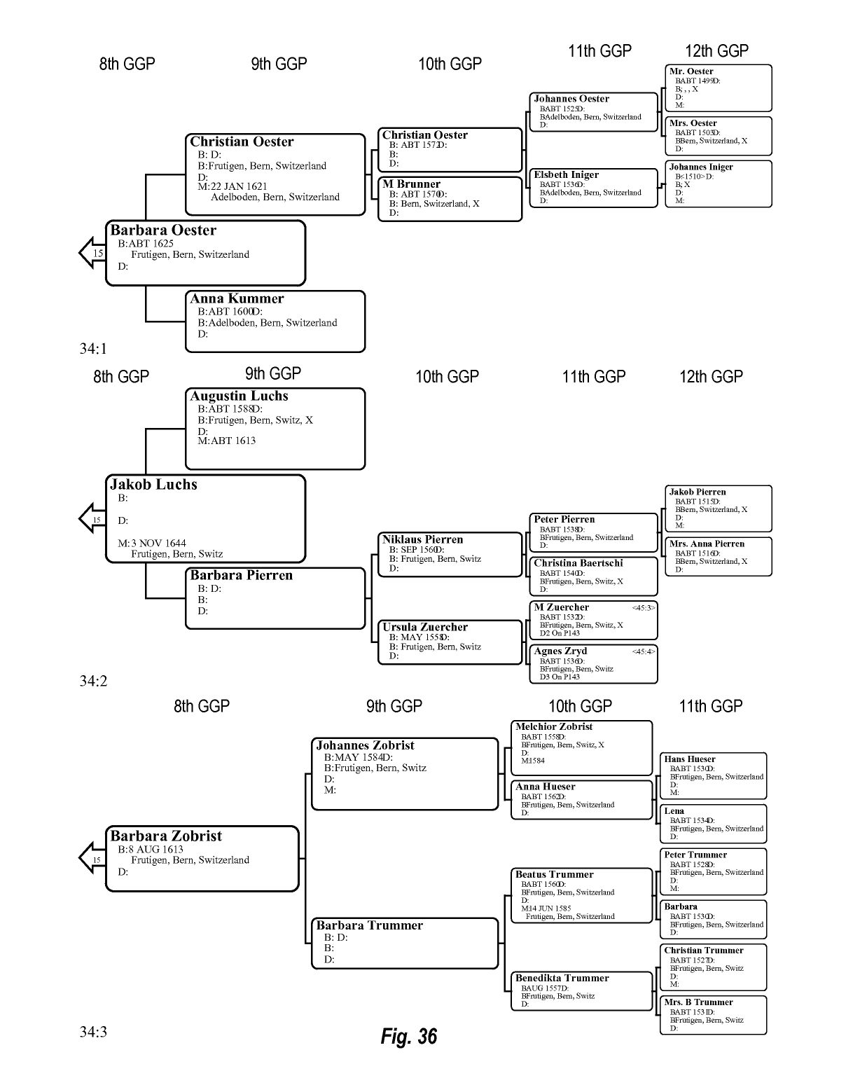

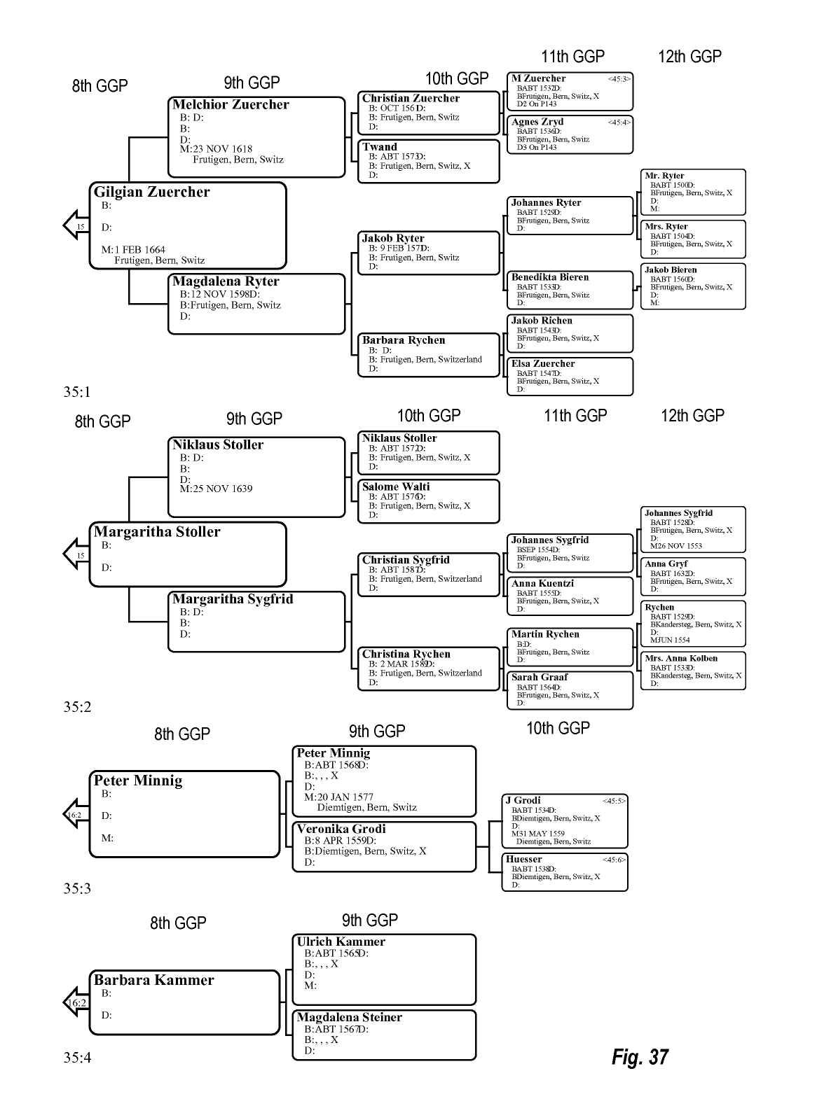

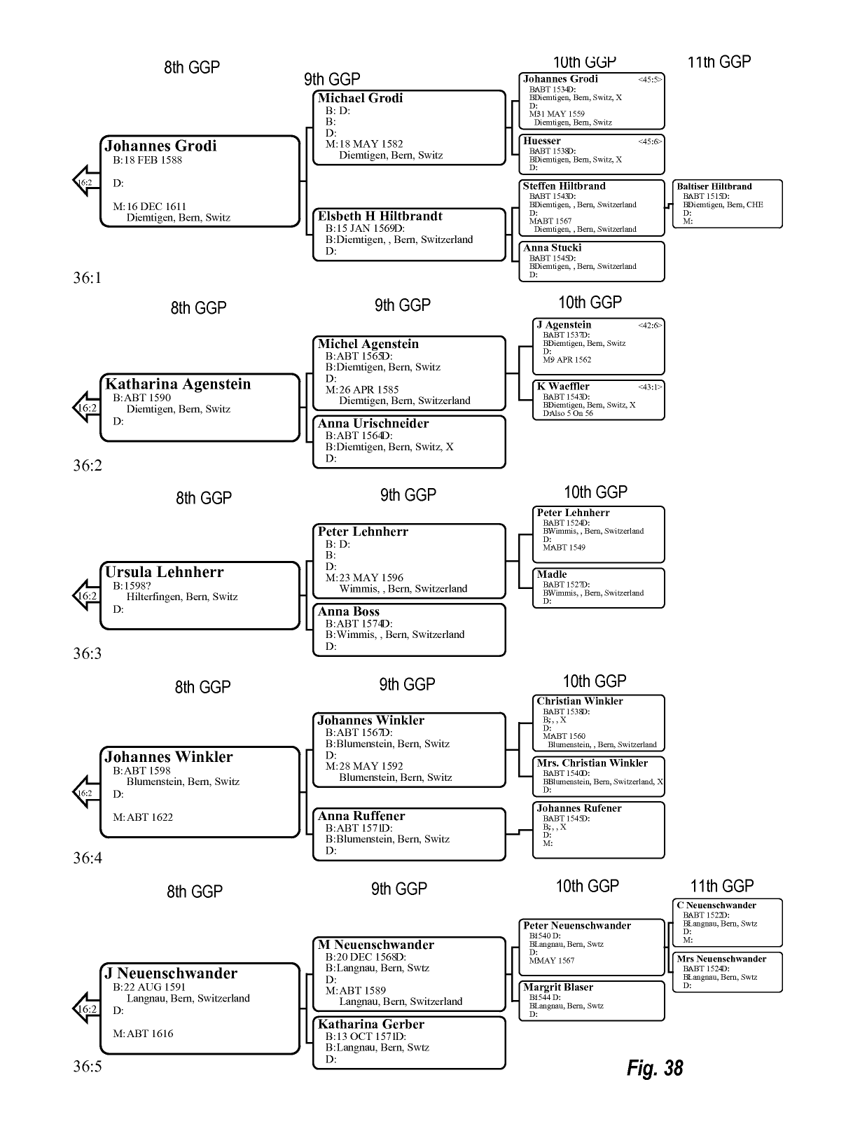

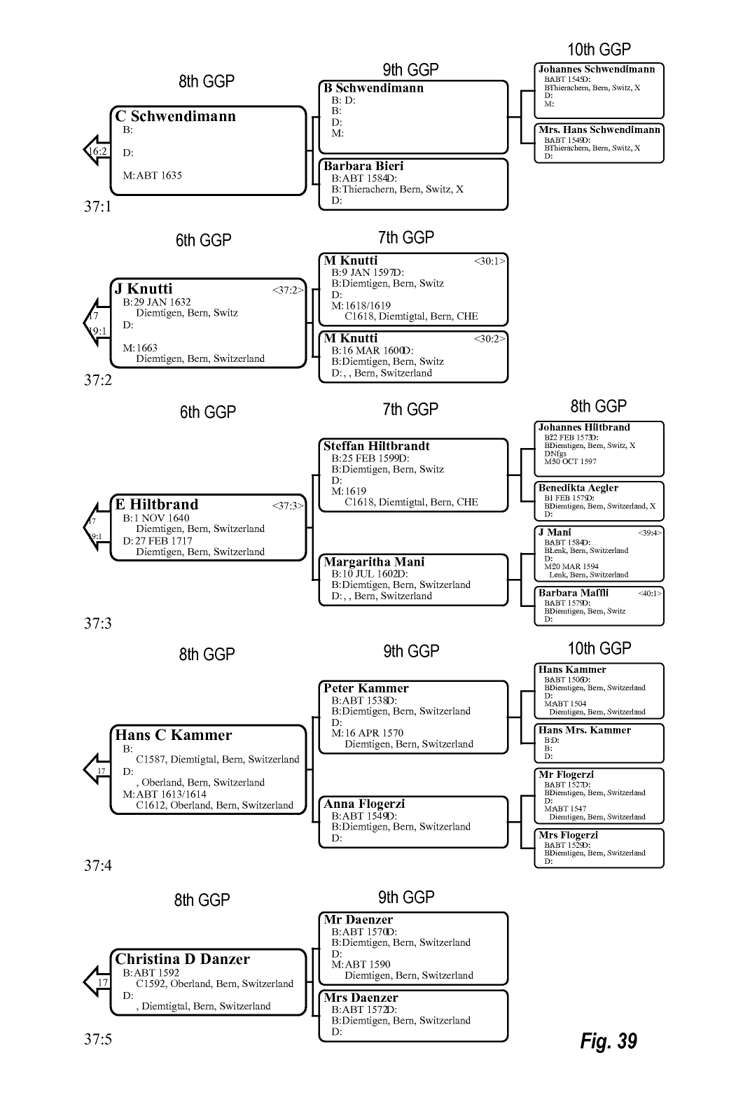

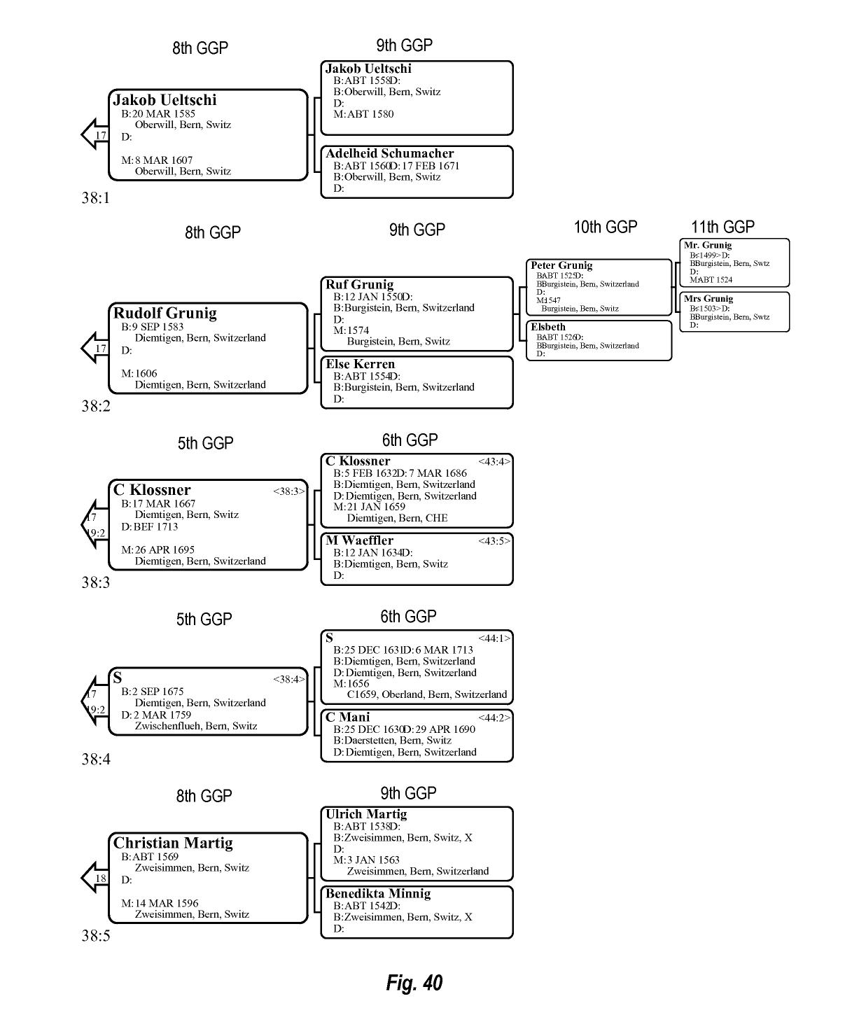

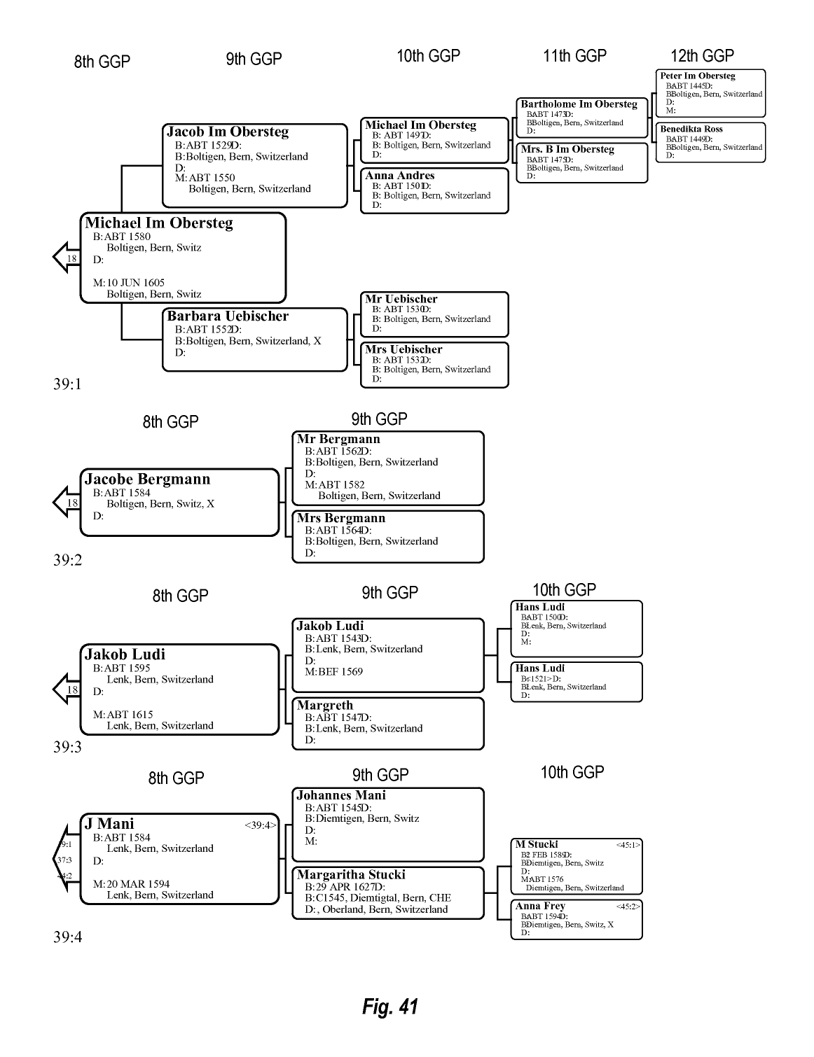

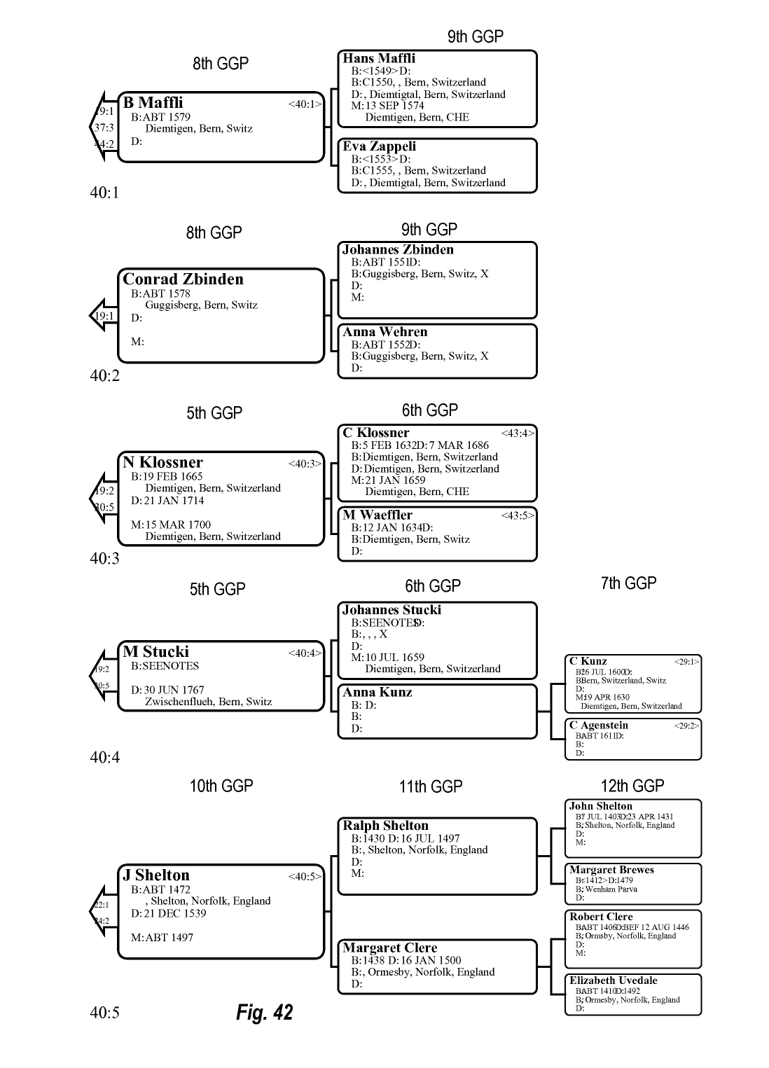

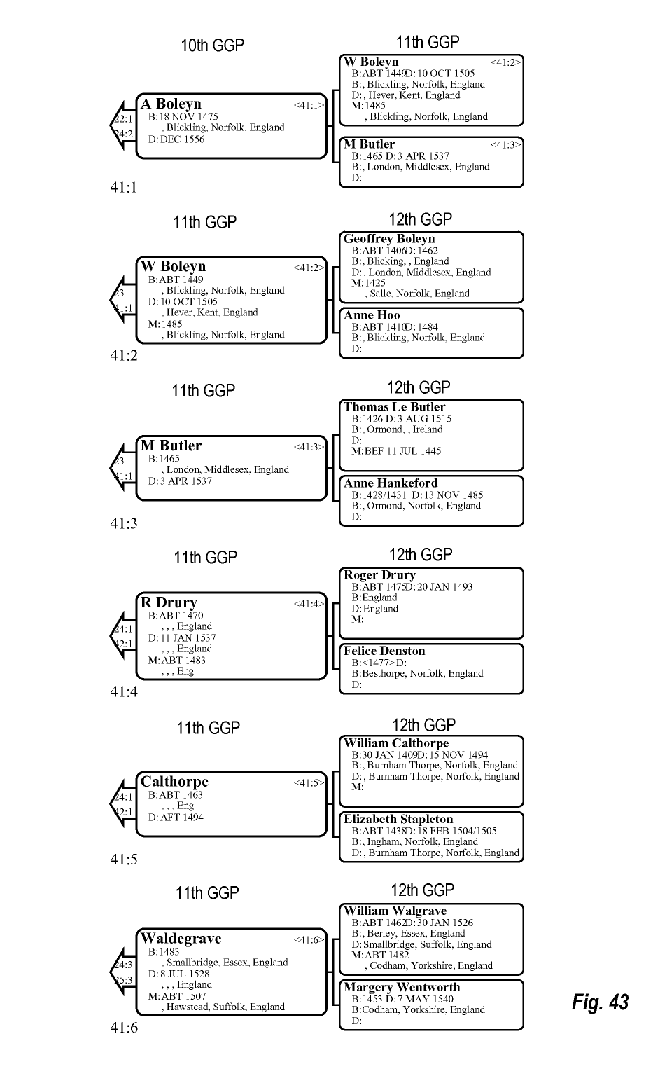

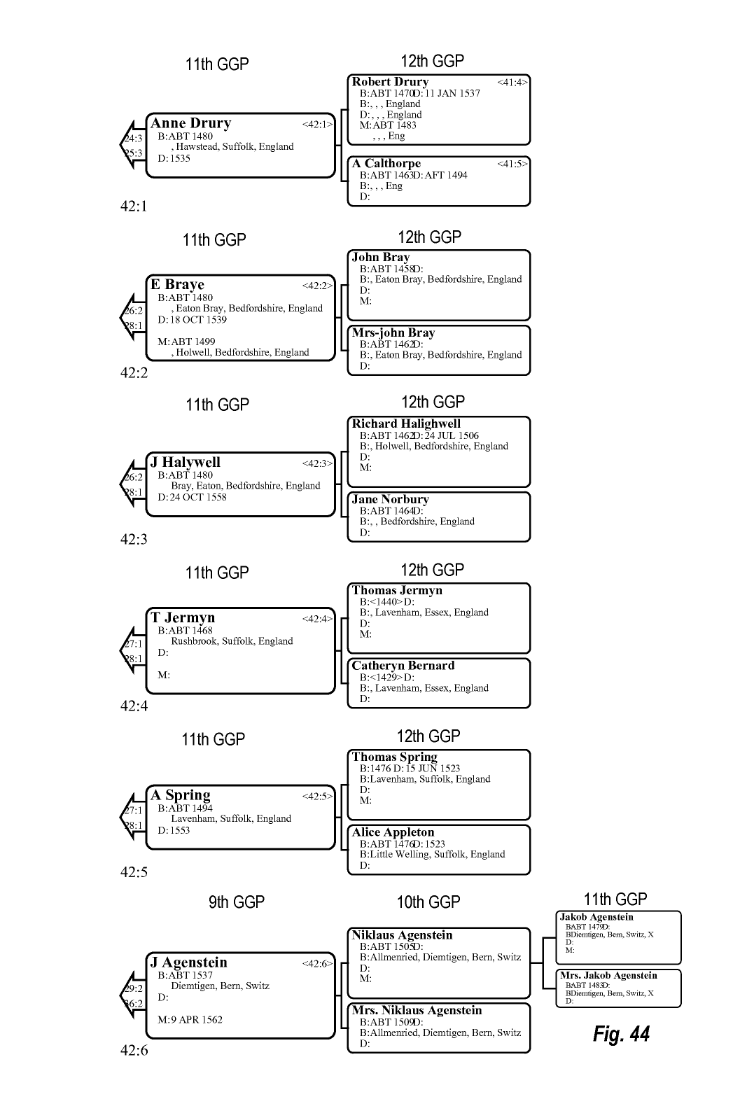

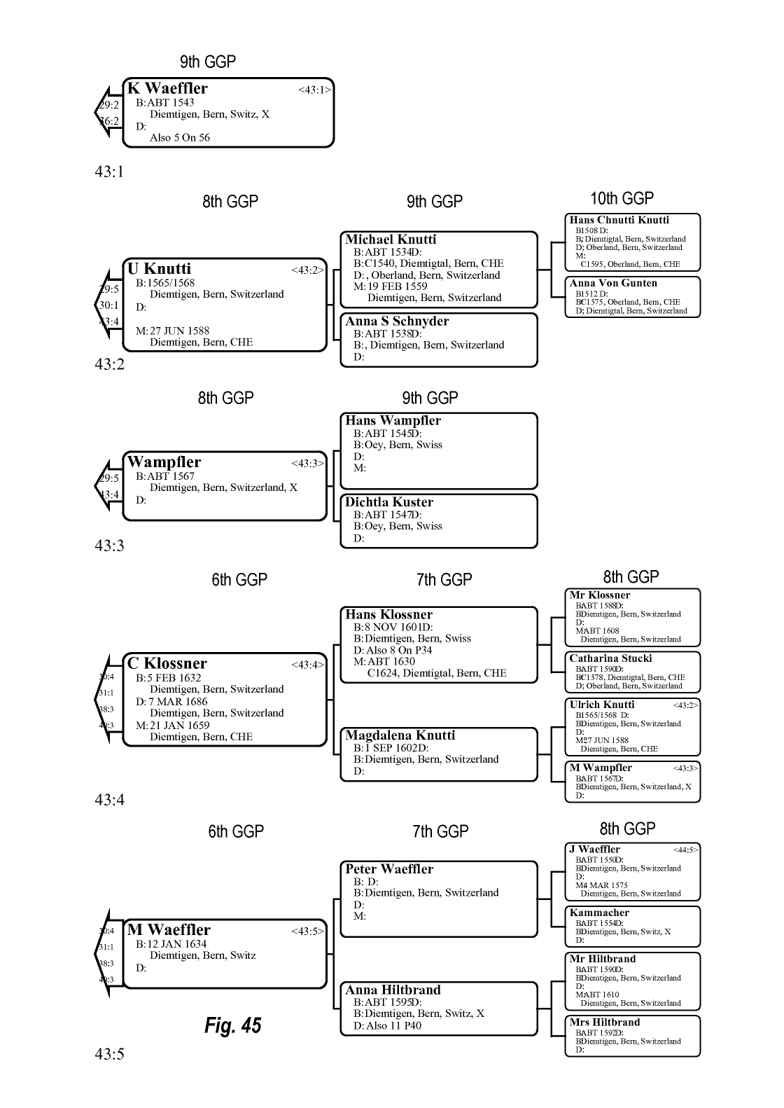

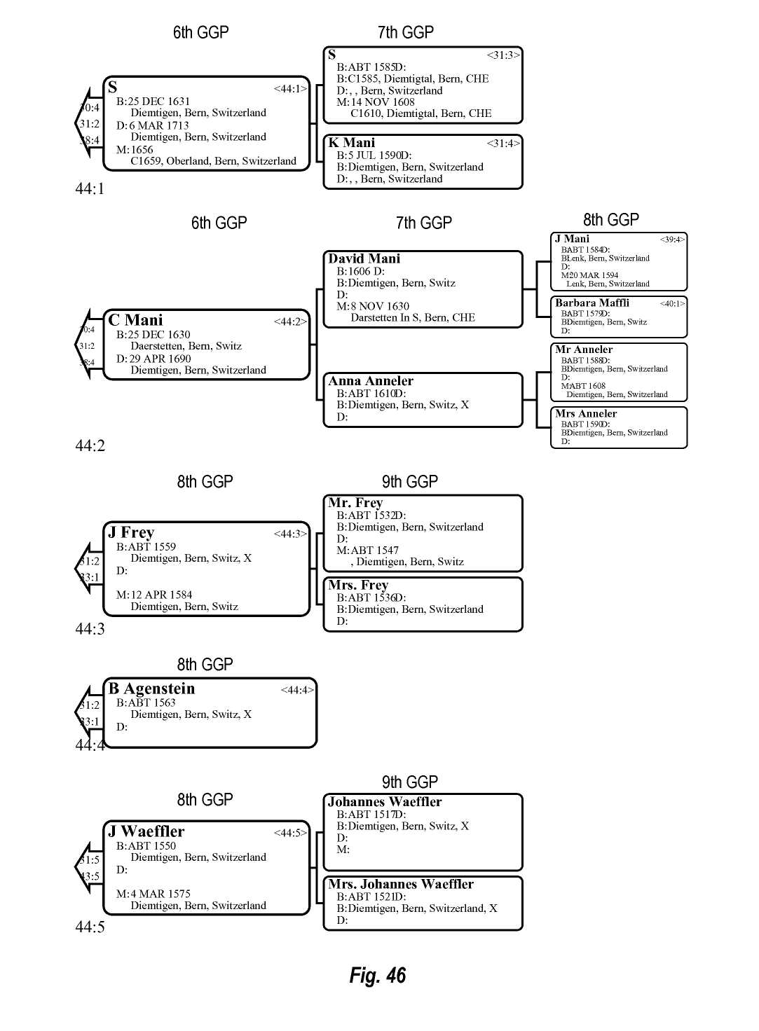

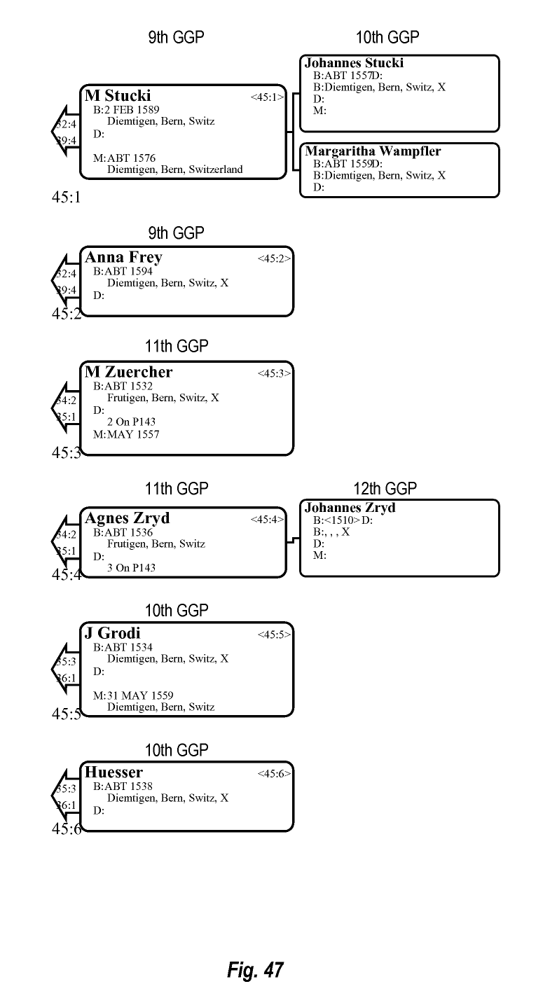

In some instances, reformatting can include forcing a physical intrusion of a child node between two parent nodes, wherein the child node was not previously presented or formatted to be positioned between the parent nodes. Various illustrations in the figures (e.g., FIGS. 3-47) show some child nodes positioned between parent nodes and others not positioned between the parent nodes.

In some embodiments, the tree is formatted according to default font and layout parameters that cause the tree to be formatted the same way, irrespective of the display constraints and/or user preferences.

After the tree is assigned a desired layout and formatted according to the appropriate settings and constraints, a determination is made as to whether the tree, as formatted, will span a plurality of viewable pages.

Then, upon determining the hierarchical layout will span a plurality of viewable pages, identification is made of the nodes that are directly related by a parent/child relationship (e.g., a parent and child node) that span different pages (160). These nodes can be thought of as descendent relative nodes (e.g., the children in the parent/child relationship spanning pages) and ancestor relative nodes (e.g., the parents in the parent/child relationship spanning pages).

The system then creates selectable page links that can be displayed on the pages corresponding to the descendent and ancestor nodes and which can be used to intuitively navigate the tree. (170 and 180). Some of these page links are referred to herein as ancestor page links since they link to correspondingly related descendants on other pages. Similarly, other page links are referred to as descendent page links since they link to the correspondingly related ancestor nodes.

Once the page links are created, the PDF viewer or other suitable viewer is used to render the tree with the corresponding pairs of ancestor page links and dependent page links that are operable, when selected, to cause the viewer to navigate to and to display the page(s) containing the linked-to ancestor nodes and dependent nodes, respectively.

Examples of the foregoing will now be described with reference to FIGS. 3-47, particularly FIGS. 3, 5 and 7, which show examples of displaying nodes of genealogical family trees which are represented in a hierarchical layout that visually reflects the family members and the relationships existing between the family members. The illustrated tree can be formatted according to a PDF viewing format or another viewing format. As shown, the illustrated tree includes selectable navigation links that interconnect directly connected nodes spanning multiple pages of the tree.

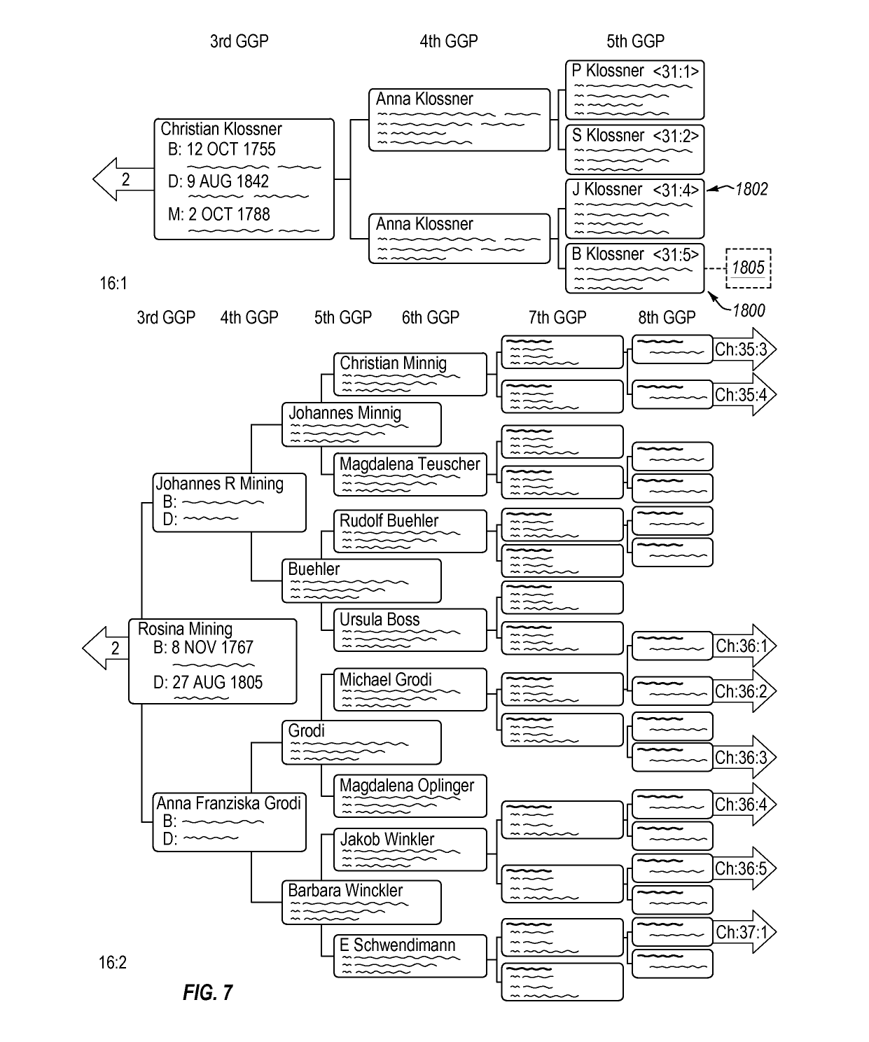

FIG. 3, for example provides a plurality of ancestor page links 300 that are each operable, when selected, to direct the viewer to a referenced chart on another page. For instance, page link 310 is selectable to redirect the viewer to chart 5:1, found on page 5 of the tree. The reference to 1 indicates that this page link is directly associated with the first chart on page 5 (FIG. 7). In this illustration, the first chart of page 5 is found in FIG. 7, corresponding to the node William Jefferies. This node in FIG. 7 also includes a descendent page link 510 having reference (512) to page 1 (FIG. 3) which, when selected, causes the viewer to display page 1 (shown in FIG. 3). In this regard, page links 510 and 310 are corresponding pairs.

Each of these page links (510 and 310) includes a reference numeral (512 and 312) to the chart that is specifically referenced by the page link. These reference numerals can be hyperlinks for operating the links 510 and 310 or they can be simple character information. Operation of the page links, therefore, can be caused by selecting the reference numerals or by selecting a graphical object displayed proximate the node having the link. In other embodiments, the node itself or a reference numeral in the node can comprise the page link (e.g., reference 1602 in FIG. 16).

FIGS. 3 and 7 also specifically reference another pair of ancestor and descendent page links (320 and 520) that have specific reference numerals (322 and 522, respectively) to call attention to and redirect the viewer to the particular page and/or chart that is referenced by the page links. When these page links are selected, the correspondingly referenced chart/page will be automatically displayed (e.g., chart/page 5:1 which is shown as reference numeral element 312 in FIG. 7 and as chart/page 5:2 which is shown as reference numeral element 322 in FIG. 7).

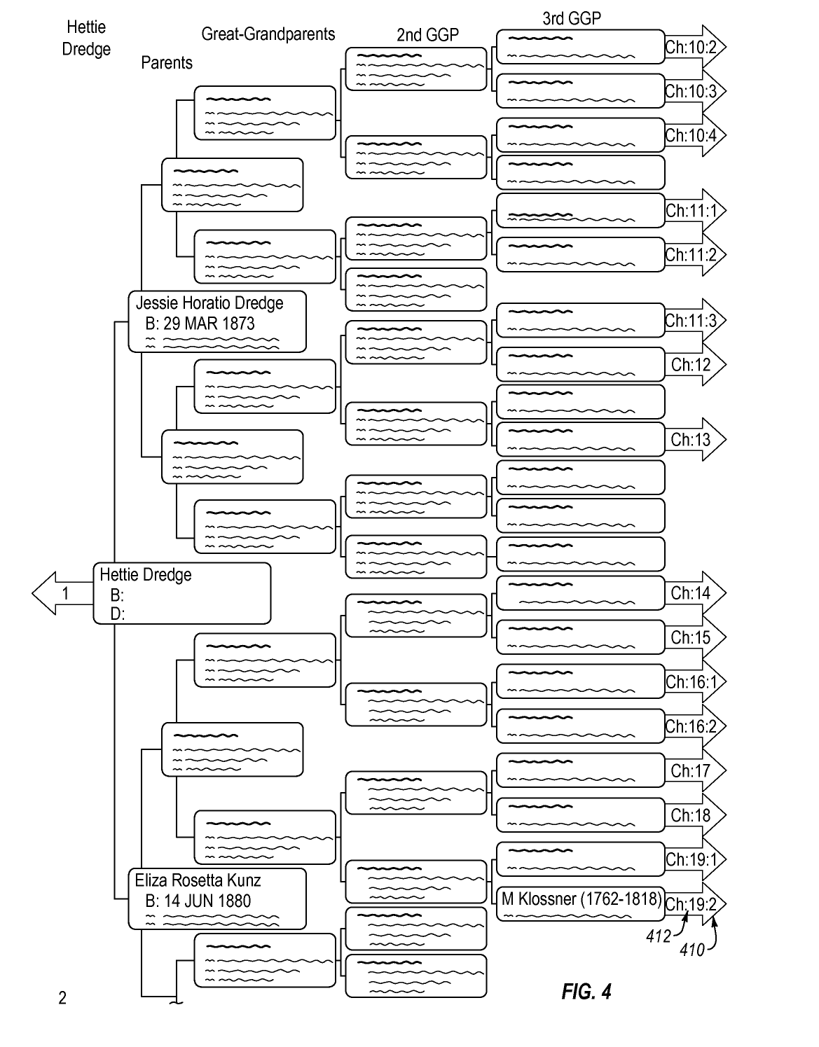

Another example, as shown in FIGS. 4 and 21, includes page link 410 and reference 412, wherein selection of ancestor page link 410 causes the viewer to display page 19 of the genealogical tree (shown in FIG. 21). It will be appreciated that the link 410 and reference 412 can also comprise the same thing, such that the text of reference 412 comprises the actual link. Alternatively, the link 410 can include or be limited to the graphical arrow shown in the Figure. Selection of decedent link 2102 will redirect the viewer to page 2, which is shown in FIG. 4.

In yet another example, with specific reference to FIGS. 3 and 4, link 400 with reference numeral 402 will cause, when selected, the viewer to display page 1 (shown in FIG. 3) where Hettie Dredge is referenced at 350. In this example, Hettie Dredge is identified as being married to or associated with Ralph A Barnes, whose genealogical tree starts on page 1 of FIG. 3. In this example, Hettie Dredge is also displayed as text in the form of a selectable page link 350 which, when selected, causes the viewer to display page 2 (FIG. 4), in which five generations of Hettie Dredge's genealogical tree is reflected.

Intelligent Formatting

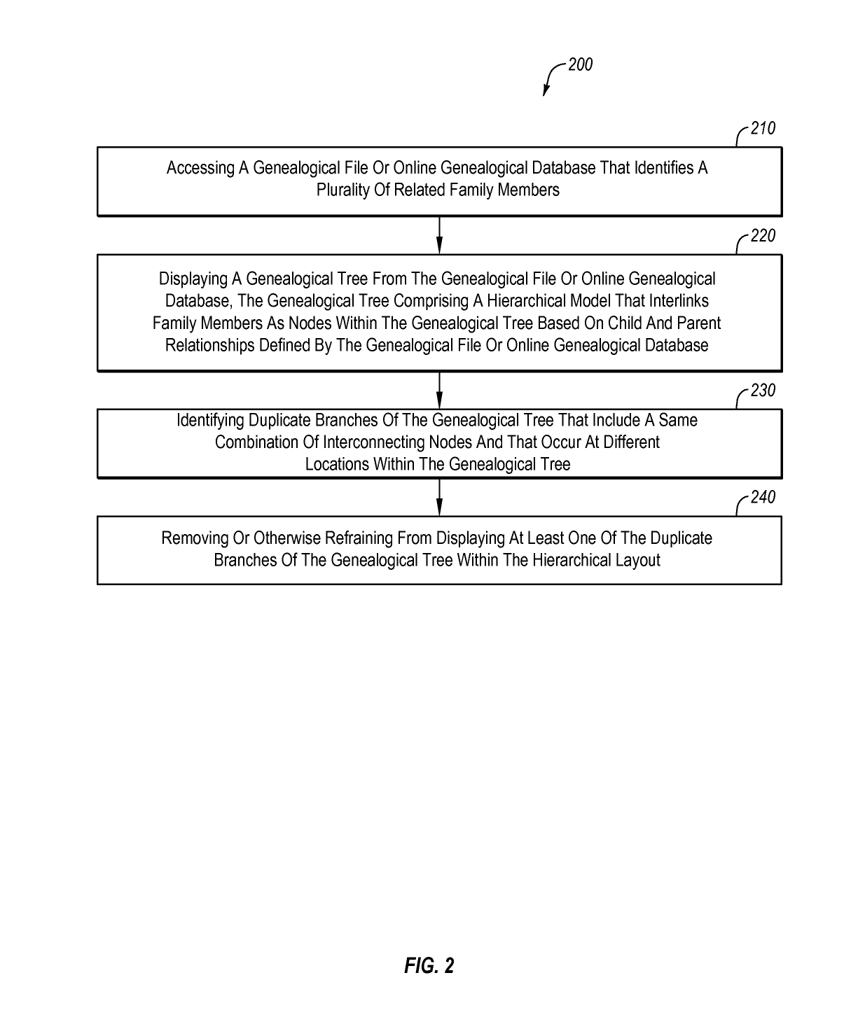

Attention will now be directed to FIG. 2, which illustrates a flowchart 200 with various acts that can be performed for efficiently modeling a genealogical tree that includes duplicate branches having an identical combination of interconnecting nodes or a combination of nodes that are determined to be the same.

The first illustrated act includes accessing a genealogical file or online genealogical database that identifies a plurality of related family members (210). This file/online database can include a gedcom or other type of file, as described above, which has not yet been formatted into a genealogical tree suitable for display. Alternatively, this file can comprise a genealogical tree model that is already formatted for display based on performing the acts described above with reference to FIG. 1.

This method also includes displaying the genealogical tree from the genealogical file or online genealogical database that comprises a hierarchical model that interlinks family members as nodes within the genealogical tree based on child and parent relationships defined by the genealogical file or online genealogical database (220). This act can be performed before and/or after performing the following acts in interactive or sequential processing.

As indicated above, some genealogical trees can include duplicate branches that have a same combination of interconnecting nodes that occur at different locations within the genealogical tree. By way of example, this can occur when cousins many and produce offspring. For these types of situations, it can be prudent to eliminate any unnecessary duplication in the family tree to minimize the overall size of the tree and to further facilitate navigation of the tree.

Accordingly, the present invention performs the act of identifying any duplicate branches (230) and removing or otherwise refraining from displaying at least one of the duplicate branches (240).

An example of the foregoing will now be presented with regard to FIGS. 16, 18 and 32. As shown in FIG. 32, a node for J Klossner (3200) has a corresponding grouping of ancestor nodes 3205 that would be unnecessarily duplicated at location 1605 and 1805 in FIGS. 16 and 18 if nodes 1600 and 1800 were displayed with their full grouping of ancestor nodes that are identical to the ancestor nodes 3205.

However, rather than display these duplications, the grouping of ancestor nodes are not displayed redundantly but are, instead, displayed only a single time as grouping 3205. To clarify this efficient formatting or reformatting, the nodes 1600 and 1800 are displayed with references (1602 and 1802) to the corresponding grouping 3205 that is found at chart 30:4 for node 3200. In some embodiments, these references (1602 and 1802) can comprise selectable ancestor page nodes.

Node 3200 is also displayed with a corresponding descendent page node 3202 that includes references (3203 and 3204) to the corresponding descendent (J Klossner) identified at nodes 1600 and 1800 in charts 14 and 16:1.

With regard to the foregoing, it is noted that duplicate branches can include combinations of nodes that are determined to be the same, even when they are not identical. Node groupings can be determined to be the same, for instance, when the differences between the groupings are relatively insignificant or fail to reach a predetermined variability threshold. This embodiment can be useful when minor discrepancies are created to due to erroneous data being extracted from the genealogical file or online genealogical database.

As described herein, the present invention includes any combination of the foregoing elements or any of the various other features recited in the claims and/or that can be inferred from the drawings.

Computing Environments

Embodiments of the present invention may also comprise or utilize a special-purpose or general-purpose computer system that includes computer hardware, such as, for example, one or more processors and system memory, as discussed in greater detail below, and that can include physical and other computer-readable media for carrying or storing computer-executable instructions and/or data structures. These computer-readable media can be any available media that can be accessed by a general-purpose or special-purpose computer system. Some of these media are physical and relatively non-transitory storage media that store computer-executable instructions and/or data structures. Other computer-readable media are signals or purely transitory carrier waves that merely carry the computer-executable instructions and/or data structures being transmitted therein. Thus, by way of example, and not limitation, embodiments of the invention can comprise at least two distinctly different kinds of computer-readable media: computer storage media and transmission media.

Some examples of physical storage media include recordable-type storage devices, such as RAM, ROM, EEPROM, solid state drives (“SSDs”), flash memory, phase-change memory (“PCM”), optical disk storage, magnetic disk storage, nonvolatile storage, or any other physical storage medium that can be used to store program code in the form of computer-executable instructions or data structures, and which can be accessed by a general-purpose or special-purpose computer system.

Examples of transmission media include networks and/or data links that can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media.

Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions, such as those that have been described herein. Computer-executable instructions may be, for example, binaries, intermediate format instructions such as assembly language, or even source code.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, multi-touch devices, tablets, pagers, routers, switches, and the like that have adequate processors, display devices and other hardware that is capable of performing the functionality described herein.

The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system by supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources include processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer storage device having stored computer-executable instructions which, when executed by at least one processor, implement a method for efficiently modeling and linking a genealogical tree spanning multiple pages with navigable links, wherein the method comprises:
accessing a genealogical file or online genealogical database containing a plurality of data items that identify family members, the genealogical file or online genealogical database containing relationship information that is usable to define relations between individual family members;
parsing the genealogical file or online genealogical database to identify relationship links between the family members based on the relationship information;
creating a genealogical tree from the parsed genealogical file or online genealogical database, the genealogical tree comprising a hierarchical model that interlinks the family members as nodes within the genealogical tree based on the relationship links, the genealogical tree including a first descendent node and a plurality of ancestor nodes with one or more relative nodes interposed between and interlinking each ancestor node with the first descendent node with corresponding relationship links;
using a Portable Document Format (PDF) viewer to render at least a portion of the genealogical tree in a hierarchical layout that visually reflects the family members and the relationship links, the hierarchical layout spanning a plurality of viewable pages when viewed by the PDF viewer based on spatial constraints for rendering the family members and their relationship links;
upon determining the hierarchical layout will span a plurality of viewable pages, identifying a descendent relative node on a particular page that is directly linked to an ancestor relative node that is displayed on a subsequent page;
creating and rendering a selectable ancestor page link proximate the descendent relative node on the particular page that is operable, when selected, to cause the PDF viewer to render the subsequent page containing the ancestor relative node; and
creating and rendering a selectable descendent page link proximate the ancestor relative node on the subsequent page that is operable, when selected, to cause the PDF viewer to render the particular page containing the descendent relative node.

2. The computer storage device of claim 1, wherein the method further includes rendering the particular page and then navigating away from the particular page to render the subsequent page directly in response to detecting user input selecting the ancestor page link from the particular page.

3. The computer storage device of claim 1, wherein the method further includes rendering the subsequent page and then navigating away from the subsequent page to render the particular page directly in response to detecting user input selecting the descendent page link from the subsequent page.

4. The computer storage device of claim 1, wherein at least one of the ancestor page link or descendent page link is displayed with a numerical reference to a page number associated with the particular page or subsequent page that is navigated to when the corresponding ancestor page link or descendent page link is selected, respectively.

5. The computer storage device of claim 1, wherein at least one of the ancestor page link or descendent page link is further displayed with the page number as well as a chart reference numeral that identifies a corresponding branch that is simultaneously charted on either the subsequent or particular page with one or more other branches of the genealogical tree.

6. The computer storage device of claim 1, wherein the method further includes identifying duplicate branches of the genealogical tree that include a same combination of interconnecting nodes and that occur at different locations within the genealogical tree.

7. The computer storage device of claim 6, wherein the method further includes removing or otherwise refraining from displaying at least one of the duplicate branches of the genealogical tree within the hierarchical layout.

8. The computer storage device of claim 6, wherein the method further includes modifying a plurality of selectable ancestor links to selectably navigate to a single representation of the combination of interconnecting nodes that correspond to the duplicate branches.

9. The computer storage device of claim 8, wherein the method further includes displaying the single representation of the combination of interconnecting nodes with one or more selectable descendent links that link to different descendent relative nodes and that, when selected, cause navigation to the different descendent relative nodes.

10. The computer storage device of claim 9, wherein the method further includes displaying the one or more selectable descendent links within a single display object with a plurality of numerical references to relative locations within the hierarchical model where each of the different descendent relative nodes are located, the numerical references comprising at least one of page reference numbers or chart reference numbers.

11. The computer storage device of claim 1, wherein the parsing of the genealogical file or online genealogical database to identify the relationship links includes creating the relationship links from the parsed genealogical file or online genealogical database.

12. The computer storage device of claim 1, wherein method further includes identifying spatial constraints for rendering the hierarchical model by the viewer and modifying a default layout associated with the hierarchical model based on the spatial constraints and upon determining that the spatial constraints prevent all of a plurality of nodes from being displayed on a single page.

13. The computer storage device of claim 12, wherein the spatial constraints comprise user defined settings associated with font size.

14. The computer storage device of claim 12, wherein the spatial constraints comprise physical dimensions of a medium used to render the hierarchical model.

15. The computer storage device of claim 1, wherein method further includes creating a visual intrusion in the hierarchical model by repositioning a child node that was positioned apart from two interlinked parent nodes in the default layout to now be interposed in a space between the interlinked parent nodes.

16. The computer storage device of claim 15, wherein method further includes creating the visual intrusion automatically in response to detecting that the repositioning will eliminate unused white space on a page where the child node is rendered.

17. The computer storage device of claim 16, wherein the method further includes rendering more nodes on the page where the child node is rendered than would be rendered with the default layout.

18. The computer storage device of claim 17, wherein the method further includes refraining from displaying the ancestor page link and the descendent page link in response to detecting that the more nodes include the ancestor relative node.

19. The computer storage device of claim 18, wherein the method further includes creating a new ancestor page link and a new descendent page link that are operable, when selected, to cause the viewer to display a page referenced by the new ancestor page link and a new descendent page link, respectively, and which interconnect directly related nodes spanning different pages.

20. The computer storage device of claim 1, wherein method further includes rendering the relationship links as lines that interconnect family members in child and parent relationships throughout the hierarchical model.

21. The computer storage device of claim 1, wherein the genealogical file or online genealogical database comprises a gedcom type file.

22. The computer storage device of claim 1, wherein the method includes formatting the genealogical model as a PDF file subsequent to creating the ancestor and descendent page links.

23. A computer storage device having stored computer-executable instructions which, when executed by at least one processor, implement a method for efficiently modeling and formatting a genealogical tree that includes duplicate branches having a same combination of interconnecting nodes, wherein the method comprises:
accessing a genealogical file or online genealogical database that identifies a plurality of related family members;
displaying a genealogical tree from the genealogical file or online genealogical database, the genealogical tree comprising a hierarchical model that interlinks family members as nodes within the genealogical tree based on child and parent relationships defined by the genealogical file or online genealogical database;
identifying duplicate branches of the genealogical tree that include a same combination of interconnecting nodes and that occur at different locations within the genealogical tree; and
removing or otherwise refraining from displaying at least one of the duplicate branches of the genealogical tree within the hierarchical layout.

24. The computer storage device of claim 23, wherein the method further includes:
parsing the genealogical file or online genealogical database to identify relationship links between the family members based on the relationship information;
creating the genealogical tree from the parsed genealogical file or online genealogical database, the genealogical tree including a first descendent node and a plurality of ancestor nodes with one or more relative nodes interposed between and interlinking each ancestor node with the first descendent node with corresponding relationship links; and
using a Portable Document Format (PDF) viewer to render at least a portion of the genealogical tree in a hierarchical layout that visually reflects the family members and the relationship links, the hierarchical layout spanning a plurality of viewable pages.

25. The computer storage device of claim 24, wherein the method further includes:
identifying a particular relative node on a particular page that is directly linked to an ancestor relative node that is displayed on a subsequent page;
creating and rendering a selectable ancestor page link proximate the particular relative node on the particular page that is operable, when selected, to cause the PDF viewer to render the subsequent page containing the subsequent relative node; and
creating and rendering a selectable descendent page link proximate the subsequent relative node on the subsequent page that is operable, when selected, to cause the PDF viewer to render the particular page containing the particular relative node.

26. The computer storage device of claim 25, wherein the method further includes modifying a plurality of selectable ancestor links to selectably navigate to a single representation of the combination of interconnecting nodes.

27. The computer storage device of claim 26, wherein the descendent link is displayed with the single representation of the combination.

28. The computer storage device of claim 27, wherein the method further includes displaying the selectable descendent link with different sub-links that each link to different descendent nodes, each of the different sub-links being displayed as different reference numerals that identify corresponding positions within the hierarchical model where the different descendent nodes are located, each of the different sub-links being individually selectable to cause a document viewer to navigate to the corresponding positions within the hierarchical model.

29. The computer storage device of claim 23, wherein identifying duplicate branches of the genealogical tree includes identifying groupings of nodes in the tree that are similar but not identical and that occur at different locations within the genealogical tree
